(19) United States
(12) Patent Application Publication
(10) Pub. No.: US 2019/0375404 A1
(43) Pub. Date: Dec. 12, 2019

(54) AUTOMATED CRUISE CONTROL SYSTEM TO AUTOMATICALLY DECREASE AN OVERALL GROUND VEHICLE ENERGY CONSUMPTION

(71) Applicant: Ali Fani Maleki, Canton, MI (US)

(72) Inventor: Ali Fani Maleki, Canton, MI (US)

(73) Assignee: Traxen Inc., Plymouth, MI (US)

(21) Appl. No.: 16/212,108

(22) Filed: Dec. 6, 2018

Related U.S. Application Data
(60) Provisional application No. 62/683,188, filed on Jun. 11, 2018.

(51) Int. Cl. B60W 30/14; B60W 40/09

(52) U.S. Cl. CPC B60W 30/143; B60W 40/09; B60W 2540/30; B60W 2900/00; B60W 2520/105; B60W 2420/42

(57) ABSTRACT

An automated cruise control system is disclosed. Sensors detect driving parameters associated with the ground vehicle as the ground vehicle maneuvers along a segment of the roadway. A ground vehicle control detector detects ground vehicle control inputs associated with an operation of the ground vehicle. The ground vehicle control inputs are generated from a longitudinal operation of the ground vehicle. A energy consumption cruise controller automatically adjusts the operation of the ground vehicle as the ground vehicle maneuvers along the segment of the roadway to maintain the operation of the ground vehicle within an operation threshold based on the detected driving parameters and ground vehicle control inputs. The operation threshold is the operation of the ground vehicle that decreases an amount of overall energy consumed by the ground vehicle and maintains a longitudinal speed of the ground vehicle within a longitudinal speed threshold.

### CROSS-REFERENCE TO RELATED APPLICATIONS

The present application is a U.S. Nonprovisional patent application which claims the benefit of U.S. Provisional Appl. No. 62/683,188, filed Jun. 11, 2018 which is incorporated herein by reference in its entirety.

### BACKGROUND

### Field of Disclosure

The present disclosure generally relates to cruise control systems of ground vehicles and specifically to the automatic adjustment of the operation of the ground vehicle as the ground vehicle maneuvers along a roadway to decrease overall energy consumption.

### Related Art

Conventional cruise control systems for ground vehicles that operate on roadways enable the driver of the ground vehicle to set the speed of the ground vehicle such that the conventional cruise control system maintains the ground vehicle at the selected set speed. The driver selects the set speed that is to be maintained without intervention by the driver. In doing so, the driver may no longer be required to operate the gas pedal of the ground vehicle but rather the conventional cruise control system maintains the ground vehicle at the set speed. The conventional cruise control system may also automatically adjust the set speed such that the ground vehicle maintains a specified distance from any ground vehicles positioned in front of the ground vehicle. As a result, the driver is not required to intervene and adjust the speed of the ground vehicle to account for ground vehicles positioned in front of the ground vehicle.

However, two different drivers may operate identical vehicles and maneuver the identical vehicles along identical routes of the identical roadway and be exposed to identical operating conditions and travel identical distances. The first driver may operate the ground vehicle with significantly less energy consumption than the second driver. Despite the identical driving environments, the first driver may operate the ground vehicle differently from the second driver thereby conserving significantly more energy consumption simply based on how the first driver operates the ground vehicle as compared to the second driver.

Any type of adjustment executed by a driver with regard to how the driver operates the ground vehicle as the driver maneuvers the ground vehicle along the roadway is simply conventionally executed by the natural intelligence of the driver. The first driver has significantly less energy consumption than the second driver simply by the decisions actually executed by the first driver. For example, the first driver applies the brake significantly less than the second driver who rides the break, the first driver coasts to a stop rather than the second driver abruptly applying to the stop, and the first driver accelerates quickly in passing and then cruises to a coasting speed while the first driver slowly accelerates and passes. Such decisions are manually executed by the first driver and results in significantly less energy consumption than the decisions of the second driver. Thus, any additional decrease in energy consumption is conventionally done by the manual decision making process of the driver and those decisions are not automatically executed by the conventional cruise control systems.

### BRIEF DESCRIPTION OF THE DRAWINGS/FIGURES

Embodiments of the present disclosure are described with reference to the accompanying drawings. In the drawings, like reference numerals indicate identical or functionally similar elements. Additionally, the left most digit(s) of a reference number typically identifies the drawing in which the reference number first appears.

FIG. 1 illustrates a block diagram of an automated cruise control system that may automatically decrease an overall energy consumption of a ground vehicle as the ground vehicle operates on a roadway.

FIG. 2A illustrates a top-elevational view of a roadway segment configuration as the geometry of the roadway changes as the grade of the roadway changes;

FIG. 2B illustrates a top-elevational view of a roadway segment configuration as the geometry of the roadway changes as the curvature of the roadway changes.

FIG. 3 illustrates a block diagram of an automated cruise control system that automatically decreases the overall energy consumption of the ground vehicle as the ground vehicle operates on a roadway;

FIG. 4 illustrates a block diagram of an automated cruise control system that automatically decreases the overall energy consumption of the ground vehicle as the ground vehicle operates on a roadway based on the vehicle load of the ground vehicle; and

FIG. 5 illustrates a block diagram of an automated cruise control system that automatically decreases the overall energy consumption of the ground vehicle as the ground vehicle operates on a roadway based on an overall driving risk level of the ground vehicle.

### DETAILED DESCRIPTION OF THE PRESENT DISCLOSURE

The following Detailed Description refers to accompanying drawings to illustrate exemplary embodiments consistent with the present disclosure. References in the Detailed Description to “one exemplary embodiment,” an “exemplary embodiment,” an “example exemplary embodiment,” etc., indicate the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic may be described in connection with an exemplary embodiment, it is within the knowledge of those skilled in the art(s) to effect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the present disclosure. Therefore, the Detailed Description is not meant to limit the present disclosure. Rather, the scope of the present disclosure is defined only in accordance with the following claims and their equivalents.

Embodiments of the present disclosure may be implemented in hardware, firmware, software, or any combination thereof. Embodiments of the present disclosure may also be implemented as instructions applied by a machine-readable medium, which may be read and executed by one or more processors. A machine-readable medium may include any mechanism for storing or transmitting information in a form readable by a machine (e.g., a computing device). For example, a machine-readable medium may include read only memory (“ROM”), random access memory (“RAM”), magnetic disk storage media, optical storage media, flash memory devices, electrical optical, acoustical or other forms of propagated signals (e.g., carrier waves, infrared signals, digital signals, etc.), and others. Further firmware, software routines, and instructions may be described herein as performing certain actions. However, it should be appreciated that such descriptions are merely for convenience and that such actions in fact result from computing devices, processors, controllers, or other devices executing the firmware, software, routines, instructions, etc.

For purposes of this discussion, each of the various components discussed may be considered a module, and the term “module” shall be understood to include at least one software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently from any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the present disclosure that others can, by applying knowledge of those skilled in the relevant art(s), readily modify and/or adapt for various applications such exemplary embodiments, without undue experimentation, without departing from the spirit and scope of the present disclosure. Therefore, such adaptations and modifications are intended to be within the meaning and plurality of equivalents of the exemplary embodiments based upon the teaching and guidance presented herein. It is to be understood that the phraseology or terminology herein for the purpose of description and not of limitation, such that the terminology or phraseology of the present specification is to be interpreted by those skilled in the relevant art(s) in light of the teachings herein.

### System Overview

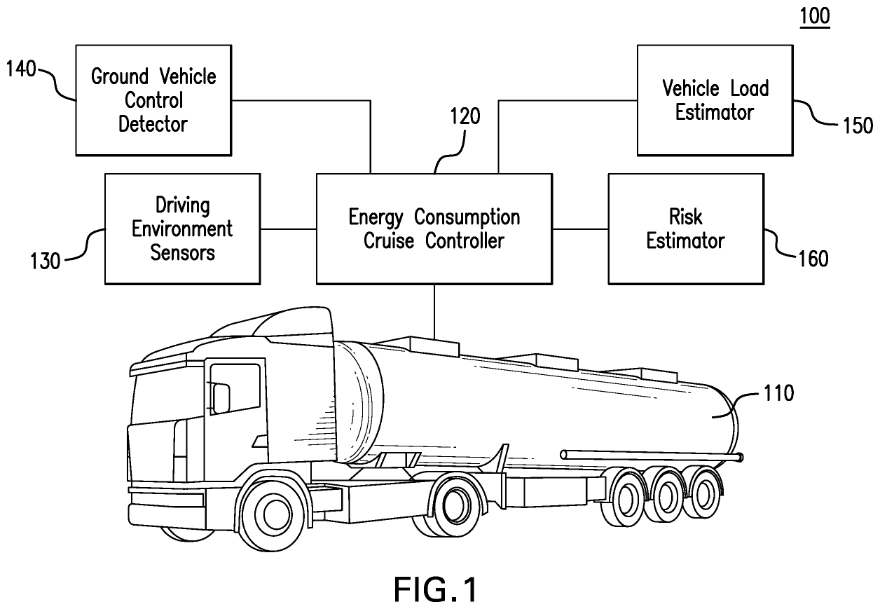

FIG. 1 illustrates a block diagram of an automated cruise control system that may automatically decrease an overall energy consumption of a ground vehicle as the ground vehicle operates on a roadway. An automated cruise control configuration 100 includes a ground vehicle 110 that may maneuver along a roadway. The ground vehicle 110 is a motorized vehicle with wheels that maneuvers along the roadway that is positioned on the ground such that wheels maintain contact with the roadway as the wheels rotate from the propulsion of a motor and the ground vehicle 110 then maneuvers along roadway via the rotation of the wheels. For example, the ground vehicle 110 may include but is not limited to a semi-truck and trailer, a semi-truck, an automobile, a motorcycle, a tractor, and/or any other ground vehicle that may maneuver along a roadway that will be apparent to those skilled in the relevant art(s) without departing from the spirit and scope of the disclosure.

An energy consumption controller 120 may automatically decrease the overall energy consumption of the ground vehicle 110 as the ground vehicle 110 maneuvers along the roadway. Rather than the driver simply setting the conventional cruise control at a set speed such that the conventional cruise control then maintains the longitudinal speed of the ground vehicle 110 at that set speed, the energy consumption controller 120 may dynamically adjust the operation of the ground vehicle 110 such that the energy consumption controller 120 automatically adjusts the operation of the ground vehicle 110 such that the ground vehicle 110 operates with a decrease in overall energy consumption. As the roadway and the conditions associated with the roadway and the driving environment of the ground vehicle 110 dynamically change, the energy consumption controller 120 may dynamically adjust the operation of the ground vehicle 110 in response to the dynamically changing conditions of the roadway and the driving environment to decrease the overall energy consumption of the ground vehicle 110. The roadway is a mapped and/or unmapped roadway that the ground vehicle 110 may operate to change locations and has a legal speed limit associated with the roadway that the ground vehicle 110 then operates at a longitudinal speed to maneuver along the roadway.

The energy when consumed by the ground vehicle 110 enables the ground vehicle 110 to operate as requested by the driver and thus the energy consumption cruise controller 120 may decrease the overall energy consumed by the ground vehicle 110 as the ground vehicle 110 operates. Energy that is consumed by the ground vehicle 110 as the ground vehicle 110 operates includes but is not limited to hydrocarbon fuels, such as gasoline and/or diesel, electric energy that is generated from coal, nuclear power, solar power, hydro power, hydrogen, natural gas and/or any other type of energy source that may generate energy that is consumed by the ground vehicle 110 as the ground vehicle 110 operates that will be apparent to those skilled in the relevant art(s) without departing from the spirit and scope of the disclosure. Energy that is consumed by the ground vehicle 110 as the ground vehicle 110 operates may also include but is not limited to liquid fuel, stored electric charge in a battery, and/or any other type of energy that is consumed by the ground vehicle 110 as the ground vehicle operates that will be apparent to those skilled in the relevant art(s) without departing from the spirit and scope of the disclosure.

The energy consumption cruise controller 120 may automatically adjust the operation of the ground vehicle 110 based on a plurality of driving environment sensors 130 that detect a plurality of driving parameters that are indicative to the driving environment that the ground vehicle 110 is operating and may change dynamically as the ground vehicle 110 maneuvers along the roadway. As the driving parameters detected by the driving environment sensors 130 change, the energy consumption cruise controller 120 may automatically adjust the operation of the ground vehicle 110 to accommodate the dynamic change in the driving parameters to thereby decrease the overall energy consumption of the ground vehicle 110 as the ground vehicle operates along the roadway. The overall energy consumption of the ground vehicle 110 is the overall energy consumed by the ground vehicle 110 as the ground vehicle maneuvers along the roadway. The energy consumption of the ground vehicle 110 may temporarily increase for a period of time, such as when the ground vehicle 110 is attempting to pass another ground vehicle as an increase in energy consumption to pass the ground vehicle 110 at a faster rate as opposed to a slower rate, may result in a greater decrease in overall energy consumption despite the temporary increase in energy consumption. Thus, a decrease in the overall energy consumption is a decrease in the energy consumed as the ground vehicle 110 maneuvers along the roadway as triggered by the automatic adjustment of the operation of the ground vehicle 110 by the energy consumption cruise controller 120 as opposed to if the energy consumption cruise controller 120 is not operating.

The energy consumption cruise controller 120 may also automatically adjust the operation of the ground vehicle 110 based on a plurality of ground control inputs that are generated from a longitudinal operation of the ground vehicle 110 and may change dynamically as the driver operates the ground vehicle 110 along the roadway. The ground control inputs may be detected by a ground vehicle control detector 140. As the driver of the ground vehicle 110 adjusts the manual operation of the ground vehicle 110, the energy consumption cruise controller 120 may automatically adjust the operation of the ground vehicle 110 to accommodate the dynamic change in the ground vehicle control inputs generated by the driver operating the ground vehicle 110 to thereby decrease the overall energy consumption of the ground vehicle 110 as the ground vehicle 110 operates along the roadway. The longitudinal operation of the ground vehicle 110 is the operation of the ground vehicle 110 as the ground vehicle 110 maneuvers in the longitudinal direction that typically follows the roadway. For example, the longitudinal speed of the ground vehicle 110 is the speed of the ground vehicle 110 as the ground vehicle 110 travels in the longitudinal direction of the roadway.

The energy consumption cruise controller 120 may also automatically adjust the operation of the ground vehicle 110 based on a plurality of vehicle load parameters that are generated from the vehicle load of the ground vehicle 110 and may change dynamically as the driver operates the ground vehicle 110 along the roadway. The vehicle load parameters may be detected by a vehicle load estimator 150. As the vehicle load parameters of the ground vehicle 110 change as the ground vehicle 110 maneuvers along the roadway, the energy consumption cruise controller 120 may automatically adjust the operation of the ground vehicle 110 to accommodate the dynamic change in the vehicle load parameters to thereby decrease the overall energy consumption of the ground vehicle 110 as the ground vehicle 110 operates along the roadway. The driving environment of the ground vehicle 110 is the overall driving environment that the ground vehicle 110 is experiencing as the ground vehicle 110 operates along the roadway such that the overall driving environment may be impacted by and/or include but is not limited to road surface conditions, the weather conditions, the traffic conditions, the visibility conditions, geometry of the roadway such as grade and curvature, speed limits, and/or any other type of condition that may impact the overall driving environment of the ground vehicle 110 that will be apparent to those skilled in the relevant art(s) without departing from the spirit and scope of the disclosure.

The energy consumption cruise controller 120 may also automatically adjust the operation of the ground vehicle based on a plurality of driving risk conditions that are associated with the driving environment of the roadway in real-time and may change dynamically as the ground vehicle 110 maneuvers along roadway. The driving risk conditions may be detected by the risk estimator 160. As the driving risk conditions of the ground vehicle 110 change as the ground vehicle 110 maneuvers along the roadway, the energy consumption cruise controller 120 may automatically adjust the operation of the ground vehicle 110 to accommodate the dynamic change in driving risk conditions to thereby decrease the overall energy consumption of the ground vehicle 110 as the ground vehicle 110 operates along the roadway. Real-time is the moment at which the ground vehicle 110 is operating along a portion of the roadway such that the driving parameters of the driving environment, the ground vehicle control inputs of the driver, vehicle load parameters of the vehicle load, driving risk conditions of the driving environment, the operation of the ground vehicle 110 and/or any other operation and/or condition and/or parameter that may be impacting the operation of the ground vehicle 110 at the moment the ground vehicle 110 is operating on that corresponding portion of the roadway that will be apparent to those skilled in the relevant art(s) without departing from the spirit and scope of the disclosure. Real-time may also include any designated period of time before the ground vehicle 110 is operating along the specific portion of the roadway as well as any designated period of time after the ground vehicle is operating along the specific portion of the roadway that will be apparent to those skilled in the relevant art(s) without departing from the spirit and scope of the disclosure.

The energy consumption cruise controller 120 may automatically adjust the operation of the ground vehicle 110 as the ground vehicle 110 maneuvers along a segment of the roadway to maintain the operation of the ground vehicle 110 within an operation threshold based on the various different parameters, inputs, conditions and/or any other type of characteristic that may impact the operation and/or maneuvering of the ground vehicle 110 as the ground vehicle maneuvers along the segment of the roadway that will be apparent to those skilled in the relevant art(s) without departing from the spirit and scope of the disclosure. The operation threshold is the operation of the ground vehicle 110 that decreases an amount of overall energy consumption by the ground vehicle 110 and maintains a longitudinal speed of the ground vehicle within a longitudinal speed threshold associated with the segment of the roadway.

The energy consumption cruise controller 120 may automatically adjust the operation of the ground vehicle 110 as the ground vehicle maneuvers along the segment of the roadway to decrease the amount of overall energy consumption by the ground vehicle 110 during the maneuvering and/or operation of the ground vehicle 110 for that specific segment. As the ground vehicle 110 maneuvers along the roadway, the geometry of the roadway may change. The geometry of the roadway are the dimensions, curvature, and/or grade of the roadway. For example, the geometry of the roadway includes but is not limited to the width of the roadway, the quantity of lanes of the roadway, the width of each lane of the roadway, the grade of the roadway, the curvatures of the roadway, and/or any other type of geometry of the roadway will be apparent to those skilled in the relevant art(s) without departing from the spirit and scope of the disclosure.

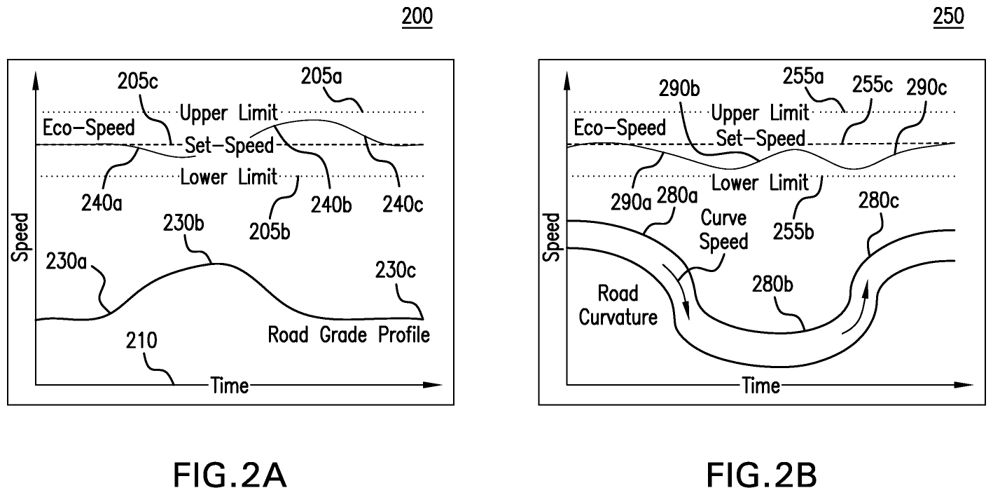

As the geometry of the roadway changes, the operation of the ground vehicle 110 in order to adapt to the change of the geometry of the roadway also changes. For example, as shown in a roadway segment configuration 200 as depicted in FIG. 2A, the geometry of the roadway changes as the grade 230(a-c) of the roadway changes. In such an example, the operating speed 240a of the ground vehicle 110 may decrease as the ground vehicle 110 attempts to transition from the flat grade 230a and to climb to the top grade 230b and the operating speed 240b may then increase as the ground vehicle 110 transitions from the top grade 230b to the flat grade 230c and the operating speed 240c may then level out as the ground vehicle maneuvers along the flat grade 230c. In another example, as shown in a roadway segment configuration 250 as depicted in FIG. 2B, the geometry of the roadway changes as the curvature 280(a-c) of the roadway changes. In another example, the operating speed 290a of the ground vehicle 110 may decrease as the ground vehicle 110 attempts to transition from the straight portion 280a and into the curvature 280b and then the operating speed 290b of the ground vehicle 110 may increase as the ground vehicle 110 departs the curvature 280b and into the straight portion 280c and the operating speed 290c may level out as the ground vehicle 110 maneuvers along the straight portion 280c. The operation of the ground vehicle 110 in order to adapt to the change of grade 230(a-c) of FIG. 2A is different from the operation of the ground vehicle 110 in order to adapt to the change of curvature 280(a-c) in FIG. 2B.

As the operation of the ground vehicle 110 changes in order to adapt to the change of the geometry of the roadway, the overall energy consumption of the ground vehicle 110 also changes. The overall energy consumption of the ground vehicle 110 to encounter the change of grade 230(a-c) in FIG. 2A is different from the overall energy consumption of the ground vehicle 110 to encounter the change of road curvature in FIG. 2B. For example, the ground vehicle 110 may steadily increase the energy consumed as the ground vehicle 110 attempts to compensate for the decrease in speed 240a as the ground vehicle 110 transitions from the flat grade 230a and to climb to the top grade 230b and the energy consumed may then steadily decrease as the ground vehicle 110 increases in speed 240b as the ground vehicle 110 transitions from the top grade 230b to the flat grade 240c. In another example, the ground vehicle 110 may rapidly decrease the energy consumed as the ground vehicle 110 quickly decreases the speed 290b to accommodate for the transition of the ground vehicle 110 from the straight portion 280c and into the curvature 280b and the energy consumed may then rapidly increase as the ground vehicle 110 increases in speed 290c as the ground vehicle 110 transitions from the curvature 280b and into the straight portion 280c.

The energy consumption cruise controller 120 may automatically adjust the operation of the ground vehicle 110 such that the operation of the ground vehicle 110 is customized to the segment of the roadway and thereby customizing the decrease in overall energy consumption to the segment of the roadway. The energy consumption cruise controller 120 may determine each segment of the roadway based on the geometry of the roadway and the corresponding operation of the ground vehicle 110 that is required to adequately maneuver along the segment of the roadway. For example, FIG. 2A depicts the first roadway segment configuration 200 in that a first segment of the roadway is depicted based on the change in grade of the roadway and then FIG. 2B depicts the second roadway segment configuration 250 in that a second segment of the roadway is depicted based on the change in curvature of the roadway. As noted above, the operation of the ground vehicle 110 as well as the overall energy consumption with regard to the change in grade in FIG. 2A differs significantly from the overall operation of the ground vehicle 110 as well as the overall energy consumption with regard to the change in curvature in FIG. 2B.

Thus, the segment of the roadway is a portion of the roadway that includes a specific geometry and thereby requires a customized operation of the ground vehicle 110 and customized overall energy consumption for the ground vehicle 110 to adequately maneuver through the segment. As the geometry of the roadway changes thereby triggering a change in operation of the ground vehicle 110 as well as a change in the overall energy consumption of the ground vehicle 110 to adequately maneuver along the change in the geometry of the roadway, the energy consumption cruise controller 120 may identify that the segment of the roadway is changing and automatically adjust the operation of the ground vehicle 110 to decrease the overall energy consumption of the ground vehicle 110 to accommodate the change in the segment of the roadway.

For example, the energy consumption cruise controller 120 may identify a first segment of the roadway to be a several mile stretch of roadway positioned on a four-lane interstate that runs through the rural train of Kansas. The grade of such a segment of the roadway may remain relatively constant for several miles due the flat terrain of Kansas. In doing so, the energy consumption cruise controller 120 may automatically adjust the operation of the ground vehicle 110 to accommodate the several mile stretch of the flat grade of the roadway to decrease the overall energy consumption of the ground vehicle 110 as the ground vehicle 110 operates along the several mile stretch of the flat grade of the roadway.

However, in another example, the energy consumption cruise controller 120 may identify a second segment to be a several hundred feet stretch of roadway that includes an abrupt curvature 280b as shown in FIG. 2B. In doing so, the energy consumption cruise controller 120 may automatically adjust the operation of the ground vehicle 110 to accommodate the several hundred feet stretch of roadway that includes the abrupt curvature 280b of the roadway to decrease the overall energy consumption of the ground vehicle 110 as the ground vehicle 110 operates along the several hundred feet stretch of the abrupt curvature 280b of the roadway. Thus, the energy consumption cruise controller 120 may automatically adjust the operation of the ground vehicle to decrease the overall energy consumption of the ground vehicle 110 for the segment of the roadway that the ground vehicle 110 is maneuvering.

As noted above, the energy consumption cruise controller 120 may automatically adjust the operation of the ground vehicle 110 to automatically adjust the operation of the ground vehicle 110 as the ground vehicle 110 maneuvers along the segment of the roadway to maintain the operation of the ground vehicle 110 within an operation threshold. The operation threshold is the operation of the ground vehicle that decreases an amount of overall energy consumption by the ground vehicle 110 and maintains a longitudinal speed of the ground vehicle 110 within a longitudinal speed threshold associated with the segment of the roadway. Rather than simply having the ground vehicle 110 operate at a set speed 205c that is set by the driver, the energy consumption cruise controller 120 may automatically adjust the operation of the ground vehicle 110 to operate within an operation threshold for the segment of the roadway and that automatic adjustment of the operation of the ground vehicle 110 may vary within the operation threshold for the segment of the roadway to decrease the overall energy consumption of the ground vehicle 110 for the segment of the roadway.

The operation threshold for the segment of the roadway is the operation that the ground vehicle 110 is to maintain in order to adequately maneuver through the segment of the roadway such that the ground vehicle 110 deviates from a set speed 205c but does so within the operation threshold such that the ground vehicle 110 adequately maneuvers throughout the segment. For example, each segment of each roadway has a specified speed limit that the ground vehicle 110 is to operate at to avoid the driver of the ground vehicle 110 to receive a traffic violation for speeding and/or for operating significantly below the speed limit. In such an example, the set speed 205c of the operation threshold may be the posted speed limit for the segment of the roadway. The energy consumption cruise controller 120 may then determine a longitudinal speed threshold associated with the segment of the roadway for the ground vehicle 110 to operate within based on the specified speed limit for the segment. The longitudinal speed threshold includes an upper limit 205a and a lower limit 205b such that as the ground vehicle 110 maneuvers along the segment of the roadway, the energy consumption cruise controller 120 may maintain the longitudinal speed of the ground vehicle to be within the upper limit 205a and the lower limit 205b of the longitudinal speed threshold. In another example, the driver may set the set speed 205c to be the speed at which the driver requests to operate. In such an example, the energy consumption cruise controller 120 may then determine the longitudinal speed threshold associated with the segment of the roadway for the ground vehicle 110 to operate within based on the specified set speed set by the user.

The energy consumption cruise controller 120 may determine the longitudinal speed threshold based on the upper limit 205a and the lower limit 205b that may ensure that the specified speed limit of the segment does not exceed and/or decrease below the specified speed limit such that the driver may be at an increased risk of receiving a traffic violation. For example, the energy consumption cruise controller 120 may incorporate that the upper limit 205a of the longitudinal speed threshold is not to exceed more than 20 mph over the specified speed limit and is not to decrease below more than 20 mph below the specified speed limit. The energy consumption cruise controller 120 may also incorporate maximum and minimum speed limits that are determined by fleet management of the fleet that the ground vehicle 110 is operating within. For example, the ground vehicle 110 may be a delivery semi-truck and trailer and the fleet management that the delivery semi-truck and trailer is operating within may require that the delivery semi-truck and trailer is not to exceed 70 mph at any time during operation. The energy consumption cruise controller 120 may then incorporate that 70 mph limit into the upper limit 205a.

The energy consumption cruise controller 120 may also determine the upper limit 205a and the lower limit 205b based on the geometry of the segment as well as the various different parameters, inputs, conditions and/or any other type of characteristics associated with the segment that may impact the operation of the ground vehicle 110 that the ground vehicle 110 should operate within a customized upper limit 205a and lower limit 205b such that the ground vehicle 110 adequately maneuvers along the segment of the roadway. For example, the energy consumption cruise controller 120 may incorporate into the upper limit 205a of the segment associated with the change in grade as shown in FIG. 2A to not exceed a specified upper limit 205a should the ground vehicle 110 increase significantly in speed transferring from the top grade 230b to the flat grade 230c to prevent the ground vehicle 110 from obtaining a longitudinal speed that may impact the ground vehicle 110 from safely maneuvering along the segment associated with the change in grade. In another example, the energy consumption cruise controller 120 may incorporate into the upper limit 255a of the segment associated with the curvature 280b as shown in FIG. 2B to not exceed a specified upper limit 255a to prevent the ground vehicle 110 from obtain a longitudinal speed that may impact the ground vehicle 110 from safely maneuvering along curvature 280b.

The energy consumption cruise controller 120 may also determine the upper limit 205a and the lower limit 205b based on an amount of time 210 that may be required by the ground vehicle 110 to adequately maneuver along the segment of the roadway. Typically, the lower the longitudinal speed that the ground vehicle 110 operates increases the likelihood that the ground vehicle 110 may safely maneuver along the segment of the roadway as well as decreasing the overall energy consumption of the ground vehicle 110. For example, the lower the longitudinal speed that the ground vehicle operates at to maneuver along the curvature 280b increases the likelihood that the ground vehicle 110 may safely maneuver along the curvature 280b while also decreasing the overall energy consumption of the ground vehicle 110. However, the ground vehicle 110 operating significantly below the posted speed limit may hinder the ground vehicle 110 from adequately operating along the segment such that the ground vehicle 110 may take an increased amount of time 210 to maneuver along the segment thereby significantly impacting the performance of the ground vehicle 110.

Thus, the energy consumption cruise controller 120 may determine the lower limit 205b of the longitudinal speed threshold to ensure that the ground vehicle 110 completes travel along the segment such that the lower limit 205b of the longitudinal speed threshold does not deviate significantly below the posted speed limit. In doing so, the energy consumption controller 120 may ensure that the ground vehicle 110 completes travel along the segment to be within a specified amount of time 210. The specified amount of time 210 may be determined by the energy consumption cruise controller 120 such that the ground vehicle 110 completes travel along the segment of the roadway without deviating significantly below the posted speed limit. In doing so, the energy consumption cruise controller 120 may determine the lower limit 205b of the longitudinal speed threshold to ensure that the ground vehicle 110 completes travel along the segment of the roadway without significantly impacting the performance of the ground vehicle 110.

The energy consumption cruise controller 120 may automatically adjust the operation of the ground vehicle 110 such that the overall energy consumption of the ground vehicle 110 may be decreased as the ground vehicle 110 maneuvers along the segment of the roadway while maintaining the longitudinal speed of the ground vehicle 110 within the longitudinal speed threshold associated with the segment of the roadway. Rather than simply having the ground vehicle operate at the set speed 205c, the energy consumption cruise controller 120 may automatically adjust the operating speed such that the overall energy consumption of the ground vehicle 110 for the segment of the roadway is decreased. In doing so, the energy consumption cruise controller 120 may automatically adjust the operating speed of the ground vehicle 120 as the ground vehicle 120 maneuvers along the segment of the roadway to ensure that the overall energy consumption is decreased.

For example, as shown in FIG. 2A, the energy consumption cruise controller 120 may automatically adjust the operating speed of the ground vehicle 110 in real-time such that the operating speed is continuously varied in real-time as the ground vehicle maneuvers along the grade 230(a-c). The energy consumption cruise controller 120 initially maintains the initial operating speed 240a at the set speed 205c as the ground vehicle attempts to climb from the flat grade 230a to the top grade 230b. The energy consumption cruise controller 120 then decreases the climbing operating speed 240b as the ground vehicle climbs the top grade 230b. Rather than have the ground vehicle 110 have a significant increase in energy consumption as the ground vehicle 110 attempts to climb the top grade 230b while maintaining the operating speed at the set speed 205c, the energy consumption cruise controller 120 may decrease the climbing operating speed 240b to the lower limit 205b of the longitudinal speed threshold in order to avoid any unnecessary increase in energy consumption by the ground vehicle 110 as the ground vehicle 110 attempts to climb the top grade 230b. The energy consumption cruise controller 120 may then increase the declining operating speed 240c to the upper limit 205a as the ground vehicle 110 transitions from the top grade 230b to the flat grade 230c as the amount of energy consumption of the ground vehicle 110 may be less as the ground vehicle 230b operates at the upper limit 205 for the declining operating speed 240c as compared to the energy consumption of the ground vehicle 110 should the ground vehicle 110 have attempted to maintain the operating speed at the set speed 205c when attempting to climb the top grade 230b.

Thus, the energy consumption cruise controller 120 may automatically adjust the operation of the ground vehicle 110 to decrease the overall energy consumption of the ground vehicle as the ground vehicle 110 maneuvers along the segment of the roadway. In doing so, the energy consumption cruise controller 120 may often times temporarily increase the operating speed of the ground vehicle 110 as the ground vehicle 110 maneuvers along the segment as such an increase in operating speed that does result in a temporary increase in energy consumption may actually result in a decrease in the overall energy consumption for the ground vehicle 110 based on the segment of the roadway that the ground vehicle 110 is operating.

In addition to the example above regarding FIG. 2A, an additional example is that the energy consumption cruise controller 120 may temporarily increase the operating speed of the ground vehicle 110 as the ground vehicle 110 is attempting to pass a second ground vehicle. Although the temporary increase in the operating speed of the ground vehicle 110 as the ground vehicle 110 accelerates to pass the second ground vehicle in a decreased amount of time, such an acceleration to pass the second ground vehicle in the decreased amount of time may result in a decrease in the overall energy consumption of the ground vehicle 110. The temporary increase in the operating speed of the ground vehicle 110 to accelerate in passing the second ground vehicle in the decreased amount of time may result in a decrease in the overall energy consumption as compared to if the ground vehicle 110 maintained the operating speed and slowly passed the second ground vehicle.

As a result, the energy consumption cruise controller 120 may automatically adjust the operation of the ground vehicle 110 to customize the operation of the ground vehicle 110 to the segment of the roadway that the ground vehicle 110 is operating to decrease the overall energy consumption of the ground vehicle 110. Rather than simply setting the operating speed and operating the ground vehicle 110 at the operating speed as well as maintaining the specified distance from other ground vehicles as conventional cruise control systems do, the energy consumption cruise controller 120 may continuously adjust the operation of the ground vehicle 110 such that the ground vehicle 110 reacts to the segment of the roadway that the ground vehicle 110 is maneuvering in real-time. Any additional adjustment to the operation of the ground vehicle 110 from operating the ground vehicle 110 at the set speed as well as maintaining a distance from other ground vehicles as provided by conventional cruise control systems to decrease the overall energy consumption has conventionally been implemented by the natural intelligence of the driver. However, any type of adjustment due to the natural intelligence of the drive obviously is limited to the natural intelligence of the driver but also any type of adjustment due to the natural intelligence of the driver is done by the perception of the driver.

For example, a driver with a higher level of natural intelligence may recognize that continuing to press on the gas pedal to maintain the operating speed at the set speed when climbing a steep incline may actually have a negative impact on the energy consumption. However, such a driver may decrease the amount of pressure on the gas pedal simply by the what the driver perceives as the appropriate amount of pressure to put on the gas pedal. Such a perception may not be the actual amount of throttle to give the ground vehicle 110 in order to decrease the overall energy consumption of the ground vehicle 110 and again is limited to the natural intelligence of the driver and the driver may not continuously execute the appropriate adjustments to the operation of the ground vehicle 110. Thus, the energy consumption cruise controller 120 may significantly decrease the overall energy consumption of the ground vehicle 110 by continuously adjusting the operation of the ground vehicle 110 in real-time based on the real-time interaction of the ground vehicle 110 with the segment of the roadway.

The energy consumption cruise controller 120 may be a device that is capable of electronically communicating with other devices. Examples of the energy consumption cruise controller 120 may include a mobile telephone, a smartphone, a workstation, a portable computing device, other computing devices such as a laptop, or a desktop computer, cluster of computers, set-top box, and/or any other suitable electronic device that will be apparent to those skilled in the relevant art(s) without departing from the spirit and scope of the disclosure.

In an embodiment, multiple modules may be implemented on the same computing device. Such a computing device may include software, firmware, hardware or a combination thereof. Software may include one or more applications on an operating system. Hardware can include, but is not limited to, a processor, a memory, and/or graphical user interface display.

### Sensor Detection Configuration

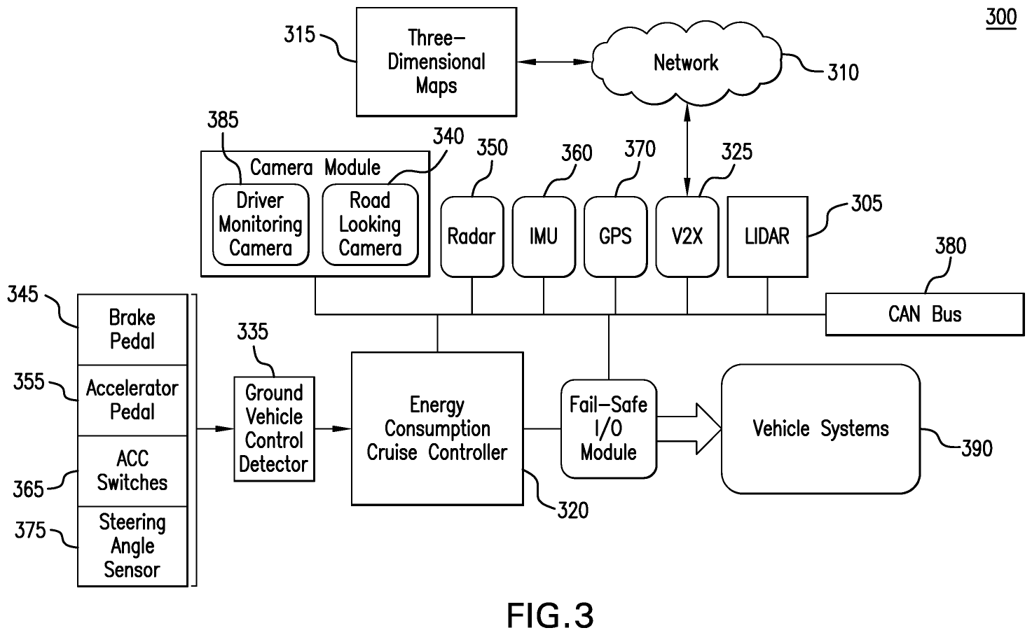

FIG. 3 illustrates a block diagram of an automated cruise control system that automatically decreases the overall energy consumption of the ground vehicle as the ground vehicle operates on a roadway. An automated cruise control system configuration 300 includes a plurality of sensors that are associated with the ground vehicle 110. The sensors include but are not limited to a road looking camera 340, a radar 350, an inertial measurement unit (IMU) 360, a global positioning system (GPS) 370, and a control area network (CAN) bus 380. The sensors detect driving parameters associated with the ground vehicle 110 as the ground vehicle 110 operates. Additional driving parameters may be detected via the vehicle to everything (V2X) connection 325 to the network 310. The energy consumption cruise controller 320 may then incorporate the driving parameters into the automatic adjustment of the ground vehicle 110 as the ground vehicle 110 operates. In doing so, the energy consumption cruise controller 320 may adjust the vehicule systems 390 of the ground vehicle 110. The automated cruise control configuration 300 shares many similar features with the automated cruise control configuration 100; therefore, only the differences between the automated cruise control configuration 300 and the automated cruise control configuration 100 are to be discussed in further detail.

A plurality of sensors, such as but not limited to the road looking camera 340, the radar 350, the IMU 360, the GPS 370, the CAN bus 380, the LIDAR 305 and so on, are associated with the ground vehicle 110 that maneuvers along the roadway. The sensors detect a plurality of driving parameters associated with the ground vehicle 110 as the ground vehicle 110 maneuvers along the segment of the roadway. The driving parameters are indicative to a driving environment that the ground vehicle 110 is operating. The driving parameters provide insight to the energy consumption cruise controller 320 as to the current driving environment that the ground vehicle 110 is operating in real-time such that the energy consumption cruise controller 320 may then incorporate the driving parameters into the automatic adjustment of the operation of the ground vehicle 110 to account for the current driving environment of the ground vehicle 110 as the ground vehicle 110 maneuvers along the segment of the roadway.

For example, the driving parameters provide insight as to the current operation of the ground vehicle 110 such as but not limited to the acceleration of the ground vehicle 110, deceleration, wheel speed and so on. The driving parameters may also provide insight as to the current external environment that the ground vehicle 110 is operating such as but not limited road lane markings, other ground vehicles positioned around the ground vehicle 110, weather conditions and so on. The driving parameters may also provide insight as to the current terrain that the ground vehicle 110 is operating such as the grade of the roadway, the map of the roadway, and so on. The driving parameters may include but are not limited to acceleration, deceleration, ground vehicle speed, wheel speed, road lane markings, position of external vehicles, position of the ground vehicle, maps, posted speed limits, upper limit and lower limits of the operating speed, 3D road map, roadway curvature, roadway grade, YAW, windshield wiper operation, anti-lock brake (ABS) activation, visibility conditions, weather conditions, landmarks associated with the roadway, cabin air temperature, cabin air pressure, road surface temperature, exhaust dew point, intake dew point and/or any other type of driving parameter that is indicative to the driving environment of the segment of the roadway that will be apparent to those skilled in the relevant art(s) without departing from the spirit and scope of the disclosure.

The energy consumption cruise controller 320 may then automatically adjust the operation of the ground vehicle 110 as the ground vehicle 110 maneuvers along the segment of the roadway to maintain the operation of the ground vehicle 110 within the operation threshold based on the detected driving parameters. Each of the numerous driving parameters detected by the sensors may enable the energy consumption cruise controller 320 to automatically adjust the operation of the ground vehicle 110 to accommodate each of the numerous driving parameters that may be impacting the driving environment of the ground vehicle 110 in real-time.

Rather than simply having the ground vehicle 110 operate at the set speed, the energy consumption cruise controller 320 may identify each driving parameter and the corresponding impact of that driving parameter on the driving environment in real-time and then automatically adjust the operation of the ground vehicle 110 based on the overall state of the driving environment in real-time. In doing so, the energy consumption cruise controller 320 may automatically adjust the vehicle systems 390 of the ground vehicle 110. The vehicle systems 390 are the systems of the ground vehicle 110 that when adjusted trigger the ground vehicle 110 to operate accordingly. For example, the vehicle systems 390 may include but are not limited to the engine controller, brakes, steering, throttle, and/or any other type of system of the ground vehicle 110 that trigger the ground vehicle 110 to operate.

A plurality of visual detection devices detects a plurality of visual detection driving parameters that are associated with the ground vehicle 110 as the ground vehicle 110 maneuvers along the segment of the roadway. The visual detection driving parameters are driving parameters that are visually identifiable as detected by the visual detection devices and are indicative to the driving environment that the ground vehicle 110 is operating. For example, the visual detection devices may include devices that detect the visual detection driving parameters that are impacting the driving environment of the ground vehicle 110 in real-time. For example, the visual detection devices may include the road looking camera 340, the radar 350, the LIDAR 305, and/or any other type of visual detection device that may detect the visual detection driving parameters that are impacting the driving environment of the ground vehicle 110 that will be apparent to those skilled in the relevant art(s) without departing from the spirit and scope of the disclosure.

The road looking camera 340, the radar 350, and/or the LIDAR 305 may detect numerous visual detection driving parameters that impact the driving environment of the ground vehicle 110 in real-time as the ground vehicle maneuvers along the segment of the roadway. The visual detection driving parameters of the driving environment may include tangible characteristics of the driving environment that may be visually detected and/or identified by the road looking camera 340, the radar, and/or the LIDAR 305 such that the driver is not required to visually detect such visual detection driving parameters. Such visual detection driving parameters may provide the energy consumption cruise controller 320 with the insight as to the tangible and/or visually identifiable aspects of the driving environment that the ground vehicle 110 is operating in real-time.

The energy consumption cruise controller 320 may then identify the visual detection driving parameters as detected by the visual detection devices in real-time as the ground vehicle 110 maneuvers along the segment of the roadway. The energy consumption cruise controller 320 may determine an impact that each of the visual detection driving parameters are having on the driving environment that the ground vehicle 110 is operating in real-time. The energy consumption cruise controller 320 may automatically adjust the operation of the ground vehicle 110 as the ground vehicle 110 maneuvers along the segment of the roadway to maintain the operation of the ground vehicle 110 within the operation threshold to accommodate for each of the visual detection driving parameters as each visual detection driving parameter impacts the driving environment that the ground vehicle 110 is operating in real-time.

For example, the road looking camera 340 may identify the amount of other ground vehicles that are operating within the field of view (FOV) of the road looking camera 340 along with the ground vehicle 110. The radar 350 and/or the LIDAR 305 may also detect the amount of other ground vehicles and the position of those ground vehicles relative to the ground vehicle 110 as the ground vehicle 110 maneuvers along the segment. The road looking camera 340, the radar 350, and/or the LIDAR 305 may identify the amount of ground vehicles that are in front of the ground vehicle 110, driving along each side of the ground vehicle 110, as well as approaching the ground vehicle 110 from the rear of the ground vehicle 110. Such visual detection driving parameters provided by the road looking camera 340, the radar 350, the LIDAR 305 may enable the energy consumption cruise controller 320 to identify the other ground vehicles that are operating within the FOV of the road looking camera 340 and/or detected by the radar 350, the LIDAR 305 and may automatically adjust the operation of the ground vehicle 110 to maintain a distance from each of the other ground vehicles.

However, such a distance that is maintained by the energy consumption cruise controller 320 may be a dynamically changing distance as opposed to a static distance. Maintaining the same specified distance from each ground vehicle may not be feasible. Rather, the energy consumption cruise controller 320 may dynamically adjust the distance that the ground vehicle 110 maintains from other vehicles based on the driving environment of the ground vehicle 110. For example, the energy consumption cruise controller 320 may maintain the distance of the ground vehicle 110 from a single ground vehicle or two ground vehicles detected by the road looking camera 340 that are also operating along a segment of the roadway that stretches several miles on a flat grade and no curvature interstate at a larger distance based on the detected increased operating speed of the ground vehicle 110 and the detection of low traffic congestion. However, in another example, the energy consumption cruise controller 320 may maintain the distance of the ground vehicle 110 from numerous ground vehicles detected by the road looking camera 340 that are also operating along a congested segment of an urban interstate at a shorter distance based on the detected decreased operating speed of the ground vehicle 110 and the detection of high traffic congestion.

The radar 340 may identify the operating speed of each of the ground vehicles that are detected by the road looking camera 340 as being within the FOV of the road looking camera 340. In identifying the visual detection driving parameter of the operating speed of each of the ground vehicles that are detected by the road looking camera 340, the energy consumption cruise controller 320 may automatically adjust the operating speed of the ground vehicle 110 to remain a dynamic distance from the other ground vehicles. The distances are determined by the energy consumption cruise controller 320 to be a safe distance from each of the ground vehicles while also decreasing the overall energy consumption of the ground vehicle but doing so within the operating threshold of the segment of the roadway.

The radar 340 identifying the visual detection driving parameter of the operating speed of the ground vehicle 110 that the ground vehicle 110 is attempting to pass may also enable the energy consumption cruise controller 320 to automatically adjust the operating speed of the ground vehicle 110 such that the energy consumption cruise controller 320 may automatically increase the operating speed of the ground vehicle 110 to adequately pass the ground vehicle while decreasing the overall energy consumption of the ground vehicle 110 while also maintaining the operation speed of the ground vehicle to be within the longitudinal speed threshold associated with the segment of the roadway. For example, the radar 340 may identify that the operating speed of the ground vehicle that the ground vehicle 110 is attempting to pass is steadily increasing the operating speed as the ground vehicle 110 attempts to pass the ground vehicle. The energy consumption cruise controller 320 may then increase the operating speed of the ground vehicle 110 to accommodate for the increase of the operating speed of the ground vehicle while ensuring a decrease in the overall energy consumption of the ground vehicle 110 as well as maintaining the operating speed of the ground vehicle 110 to be within the longitudinal speed threshold of the segment of the roadway.

The road looking camera 340, the radar 350, and/or the LIDAR 305 may also identify the geometry of the segment of the roadway based on the width of the roadway, the amount of lanes of the roadway, as well as provide real-time updates as to the operation of the ground vehicle 110 relative to the operating lines of the roadway to determine whether the ground vehicle 110 is operating within the operating lines and/or moving across the operating lines. Such driving parameters provided by the road looking camera 340, the radar 350, and/or the LIDAR 305 may enable the energy consumption cruise controller 320 to determine whether the ground vehicle 110 is safely operating within the operating lines of the roadway. The energy consumption cruise controller 320 may automatically adjust the operation of the ground vehicle 110 to enable the ground vehicle 110 to operate at an increased operating speed when the ground vehicle 110 is safely operating within the operating lines of the roadway. However, the energy consumption cruise controller 320 may automatically adjust the operation of the ground vehicle to decrease the operating speed when the ground vehicle 110 is not safely operating within the operating lines of the roadway but is rather crossing the operating lines.

The road looking camera 340, the radar 350, and/or the LIDAR 305 may also identify the current state of the weather with regard to the current atmospheric conditions of the driving environment that the ground vehicle 110 is operating. The road looking camera 340 may identify when rain is initiated as well as the intensity of the rain as the ground vehicle 110 is operating with regard to the visibility of the roadway for the driver. The road looking camera 340 may identify when snow is initiated as well as the intensity of the snow as the ground vehicle is operating with regard to the visibility of the roadway for the driver. The road looking camera 340 may identify when the intensity of the sun is impacting the visibility of the roadway for the driver. The road looking camera 340 may determine when the glare of external lights not positioned on the ground vehicle 110 impact the visibility of the driver at night.

The driving parameters of the rain and/or snow may trigger the energy consumption cruise controller 320 to automatically adjust the operation of the ground vehicle 110 to decrease the operating speed of the ground vehicle 110 to account for the intensity of the rain and/or snow. The energy consumption cruise controller 320 may decrease the operating speed to be closer to the lower limit 205b of the longitudinal speed threshold based on the intensity of the rain and/or snow. As the intensity of the rain and/or snow increases, the energy consumption cruise controller 320 may decrease the operating speed to be significantly closer to the lower limit 205b. The energy consumption cruise controller 320 may adjust the longitudinal speed threshold to decrease the longitudinal speed threshold such that the upper limit 205a and the lower limit 205b are decreased further when the intensity of the rain and/or snow is significant.

The speed and/or operation of the windshield wipers positioned on the ground vehicle 110 may also provide the driving parameters as to the intensity of the rain and/or snow. As the speed of the windshield wipers increase, the energy consumption cruise controller 320 may recognize that the intensity of the rain and/or snow is also increasing. The application of the ABS positioned on the ground vehicle 110 may also provide the driving parameters as to the conditions of the segment of the roadway with regard to slickness of the segment of the roadway from rain, snow, and/or ice. As the ABS is applied, the energy consumption cruise controller 320 may recognize that the slickness of the segment of the roadway is increasing.

The road looking camera 340, the radar 350, and/or the LIDAR 305 may also identify the posted speed limit signs that are positioned along the segment of the roadway as well as any changes in the posted speed limit of the posted speed limit signs. A significant driving parameter for the segment of the roadway is the posted speed limit for the segment of the roadway. The energy consumption cruise controller 320 may determine the operating threshold for the segment of the roadway as well as the longitudinal speed threshold for the segment of the roadway that the ground vehicle 110 is to operate when maneuvering along the segment of the roadway based on the posted speed limit for the roadway. The energy consumption cruise controller 320 may ensure that the longitudinal speed threshold for the segment of the roadway is set such that the upper limit 205a and the lower limit 205b of the longitudinal speed threshold for the segment of the roadway decreases the likelihood that the driver may receive a traffic violation for either exceeding and/or decreasing below the posted speed limit for the segment of the roadway.

The road looking camera 340, the radar 350, and/or the LIDAR 305 may then provide the energy consumption cruise controller 320 with any change in the posted speed limit signs. The energy consumption cruise controller 320 may then automatically adjust the longitudinal speed threshold for the segment of the roadway to accommodate the change in the posted speed limit sign detected by the road looking camera, the radar 305, and/or the LIDAR 305. In doing so, the energy consumption cruise controller 320 may then ensure that the ground vehicle 110 operates within a longitudinal speed threshold that is adjusted to accommodate the change in the posted speed limit signs. The road looking camera 340, the radar 350, and/or the LIDAR 305 may detect and provide any type of visual detection driving parameter to the energy consumption cruise controller 320 that may enable the energy consumption cruise controller 320 to automatically adjust the operation of the ground vehicle 110 to account for the impact of the visual detection driving parameter detected by the camera 340, the radar 350, and/or the LIDAR 305 that will be apparent to those skilled in the relevant art(s) without departing from the spirit and scope of the disclosure.

The IMU 360 may detect numerous driving parameters that impact the driving environment of the ground vehicle 110 as the ground vehicle 110 maneuvers along the segment of the roadway. The IMU 360 may detect movement aspects of the driving environment in that the movement aspects include characteristics of the driving environment that are associated with the movement of the ground vehicle 110 that may be detected by the IMU 360. Such movement aspects may provide the energy consumption cruise controller 320 with the insight as to the aspects associated with the driving environment related to the movement of the ground vehicle 110 as the ground vehicle 110 maneuvers along the segment of the roadway in real-time.

For example, the IMU 360 may identify in real-time driving parameters such as but not limited to the operation speed of the ground vehicle 110, acceleration of the ground vehicle 110, deceleration of the ground vehicle 110, wheel speed of the ground vehicle 110, the YAW of the ground vehicle 110, and/or any other type of driving parameter that is associated with the movement of the ground vehicle 110 as the ground vehicle operates in the driving environment will be apparent to those skilled in the relevant art(s) without departing from the spirit and scope of the disclosure. The energy consumption cruise controller 320 may then incorporate the driving parameters detected by the IMU 360 in real-time to adjust the operation of the ground vehicle 110 in real-time based on the movement of the ground vehicle 110 as identified by the driving parameters detected by the IMU 360.

The IMU 360 may provide the acceleration and/or deceleration of the ground vehicle 110, wheel speed of the ground vehicle 110, and/or the YAW of the ground vehicle 110 to the energy consumption cruise controller 320. The energy consumption cruse controller 320 may then determine in real-time the status of the ground vehicle 110 regarding how the ground vehicle 110 is moving in the driving environment and then automatically adjust the operation of the ground vehicle based on the real-time status of the ground vehicle 110. For example, the IMU 360 detects that the ground vehicle 110 is accelerating and thereby increasing the operating speed of the ground vehicle 110 to reaching the upper limit 205a of the longitudinal speed threshold of the change in grade segment of the roadway depicted in FIG. 2A as the ground vehicle 110 transitions from the top grade 230b to the flat grade 230c. However, quickly following the flat grade 230c the segment of the roadway may change from the change in grade segment of the roadway depicted in FIG. 2A to the curvature segment of the roadway depicted in FIG. 2B.

Based on the driving parameters of the increase in acceleration and operating speed at the upper limit 205a as the ground vehicle 110 enters the curvature 280b as detected by the IMU 360, the energy consumption cruise controller 320 may then automatically adjust the deceleration of the ground vehicle 110 as well as decreasing the operating speed of the ground vehicle 110 to reach the lower limit 255b of the longitudinal speed threshold of the curvature segment of the roadway at an increased deceleration rate. The energy consumption cruise controller 320 may automatically increase the deceleration rate of the ground vehicle 110 as the ground vehicle reaches the curvature 280b to trigger the ground vehicle 110 to reach the lower limit 255b of the longitudinal speed threshold of the curvature segment of the roadway significantly quicker as compared to when the ground vehicle 110 is entering the curvature 280b at an operating speed that is at the set speed 255c for the curvature segment of the roadway with limited acceleration. In doing so, the energy consumption cruise controller 320 may automatically adjust the operation of the ground vehicle 110 in real-time to ensure that the ground vehicle 110 reaches the lower limit 255b of the longitudinal speed threshold of the curvature 280b such that the ground vehicle 110 maneuvers through the curvature 280b safely.

Thus, the driving parameters detected by the IMU 360 associated with the real-time movement of the ground vehicle 110 relative to the driving environment of the ground vehicle 110 may enable the energy consumption cruise controller 320 to automatically adjust the operation of the ground vehicle 110 to accommodate for the real-time movement of the ground vehicle 110. Rather than have the driver override the conventional cruise control should the ground vehicle 110 be approaching a segment of the roadway, such as the curvature 280b at such a high operating speed that is unsafe for the driver to maneuver through the curvature 280b, the energy consumption cruise controller 320 may automatically adjust the operating speed of the ground vehicle 110 to accommodate for the operating speed as the ground vehicle 110 encounters each segment of the roadway. The IMU 360 may detect and provide any type of driving parameter to the energy consumption cruise controller 320 that may enable the energy consumption cruise controller 320 to automatically adjust the operation of the ground vehicle 110 to account for the impact of the driving parameter detected by the IMU 360 that will be apparent to those skilled in the relevant art(s) without departing from the spirit and scope of the disclosure.

The GPS 370 may detect the position of the ground vehicle 110 as the ground vehicle 110 maneuvers along segment of the roadway relative to the roadway and the driving environment of the ground vehicle 110. As the position of the ground vehicle 110 changes in real-time, the GPS 370 may provide the driving parameter of the position of the ground vehicle 110 to the energy consumption cruise controller 320. In doing so, the energy consumption cruise controller 320 may automatically adjust the operation of the ground vehicle 110 based on the position of the ground vehicle 110 in real-time relative to the driving environment of the ground vehicle 110. The energy consumption cruise controller 320 may localize the position of the ground vehicle 110 relative to the driving environment of the ground vehicle 110 via the GPS 370 such that the energy consumption cruise controller 320 may incorporate the localized position of the ground vehicle 110 relative to three-dimensional (3D) maps 315 of the driving environment.

The V2X 325 of the ground vehicle 110 may continuously stream 3D maps 315 of the driving environment to the energy consumption cruise controller 320 based on the position of the ground vehicle 110 as detected by the GPS 370. The energy consumption cruise controller 320 may then incorporate the position of the ground vehicle 110 as detected by the GPS 370 into the 3D maps 315 of the driving environment and then analyze the 3D maps 315 as the position of the ground vehicle 110 changes in real-time relative to the driving environment as depicted in the 3D maps 315. The 3D maps 315 may provide numerous driving parameters that have terrain aspects of the driving environment in that the terrain aspects include characteristics of the driving environment that are associated with the geometry of the segment of the roadway as well as other aspects of the terrain surrounding the ground vehicle 110 as the ground vehicle 110 maneuvers along the segment of the roadway. Such terrain aspects may provide the energy consumption cruise controller 320 with the insight as to the aspects associated with the geometry of the driving environment as well as other aspects of the terrain of the driving environment as the ground vehicle 110 maneuvers along the segment of the roadway in real-time.

For example, the 3D maps 315 in real-time may provide driving parameters such as but not limited to ascending grades of the segment of the roadway, descending grades of the segment of the roadway, curvature of the segment of the roadway, posted signage, maps of the segment of the roadway, terrain of the segment of the roadway, look ahead maps of the roadway beyond the segment of the roadway, landmarks associated with the segment of the roadway, posted speed limit signs, and/or any other type of driving parameter that is associated with the geometry and/or terrain of the segment of the roadway as the ground vehicle 110 operates in the driving environment that will be apparent to those skilled in the relevant art(s) without departing from the spirit and scope of the disclosure. The energy consumption cruise controller 320 may then incorporate the driving parameters provided by the 3D maps 315 in real-time to adjust the operation of the ground vehicle 110 in real-time based on the geometry and/or terrain of the segment of the roadway as identified by the driving parameters provided by the 3D maps 315.

As discussed in detail above, the energy consumption cruise controller 320 may incorporate the driving parameters associated with the geometry and/or terrain of the segment of the roadway to automatically adjust the operation of the ground vehicle 110 based on the geometry and/or terrain of the segment of the roadway. The geometry and/or terrain of the segment of the roadway as determined from the 3D maps 315 by the energy consumption cruise controller 320 may have a significant impact as to how the energy consumption cruise controller 320 adjusts the operation of the ground vehicle 110 to accommodate for the geometry and/or terrain of the segment of the roadway. In doing so, the energy consumption cruise controller 320 may determine the necessary driving parameters associated with the geometry and/or terrain of the segment of the roadway as determined from the 3D maps 315 to adjust the operation of the ground vehicle 110 as the geometry and/or terrain of the segment of the roadway changes in real-time. The 3D maps 315 may provide any type of driving parameter to the energy consumption cruise controller 320 that may enable the energy consumption cruise controller 320 to automatically adjust the operation of the ground vehicle 110 to account for the impact of the driving parameters provided by the 3D maps 315 that will be apparent to those skilled in the relevant art(s) without departing from the spirit and scope of the disclosure.

The energy consumption cruise controller 320 may also monitor numerous driving parameters associated with the CAN bus 380 of the ground vehicle 110. The CAN bus 380 may be receiving numerous signals triggered by numerous components and/or sensors associated with the ground vehicle 110 as the ground vehicle maneuvers along the segment of the roadway. The energy consumption cruise controller 320 may monitor the numerous driving parameters associated with the CAN bus 380 and then automatically adjust the operation of the ground vehicle 110 based on the numerous driving parameters associated with the CAN bus 380.

The energy consumption cruise controller 320 may automatically adjust the operation of the ground vehicle 110 as the ground vehicle attempts to pass another ground vehicle when maneuvering along the segment of the roadway. Conventional cruise control systems require that the driver override the set speed in order to adequately maneuver into the contingent lane and then adequately accelerate to pass the other ground vehicle and then adequately maneuver back into the lane after passing the other ground vehicle. However, the energy consumption cruise controller 320 may identify the driving parameters that are indicating that the driver is requesting to pass the ground vehicle and in doing so may automatically adjust the operation of the ground vehicle 110 to adequately pass the other vehicle without requiring the driver to intervene and override the energy consumption cruise controller 320.

As the ground vehicle 110 approaches the other ground vehicle from the rear while in the same lane as the other ground vehicle, the road looking camera 340 and the radar 350 may detect the other ground vehicle as the ground vehicle 110 approaches the other ground vehicle. The driver may then initiate lateral movement via the steering wheel to transition the ground vehicle 110 to the contingent lane in order to pass the ground vehicle. At that point, the YAW of the lateral movement triggered by the driver initiating the lateral movement via the steering wheel to move the ground vehicle 110 into the contingent lane may be detected by the IMU 360.

The energy consumption cruise controller 320 may then recognize from the driving parameter that the other ground vehicle is initially captured by the road looking camera 340 and the radar 350 as being in front of the ground vehicle and then the driving parameter that the other ground vehicle is no longer captured by the road looking camera 340 and the radar 350 due to the lane change coupled with the driving parameter of the YAW as detected by the IMU 360 indicating a lane change that the driver is actually attempting to pass the other ground vehicle. Based on that recognition, the energy consumption cruise controller 320 may then automatically adjust the acceleration and increase the set speed of the ground vehicle 110 to pass the other ground vehicle but doing so within the operation threshold for the segment of the roadway. In doing so, the energy consumption cruise controller 320 may automatically adjust the acceleration and increase the set speed of the ground vehicle 110 to pass the other ground vehicle while maintaining the operating speed within the longitudinal speed threshold for the segment of the roadway while decreasing the overall energy consumption of the ground vehicle for the segment of the roadway.

The driver of the ground vehicle 110 may then laterally transition the ground vehicle back to the initial lane via the steering wheel after adequately passing the other ground vehicle. The IMU 360 may then detect the YAW of the ground vehicle 110 in the lateral transition to the initial lane. The sinusoidal reaction of the YAW as the ground vehicle 110 transitioned from the initial lane to the contingent lane to pass the other ground vehicle and then the transition back into the initial lane after completing the pass of the other vehicle may be recognized by the energy consumption cruise controller 320 as the driver attempting to pass the other ground vehicle regardless as to operating speed in which the ground vehicle 110 operates to complete the pass of the other ground vehicle. The energy consumption cruse controller 110 may then be based on the sinusoidal reaction of the YAW as detected by the IMU 360 recognize that the driver is attempting to complete the pass of the other ground vehicle and transition back into the initial lane. The energy consumption cruise controller 320 may then automatically adjust the operation of the ground vehicle 110 to accommodate the maneuvering along the segment of the roadway after completion of the pass of the other vehicle.

### Ground Vehicle Control Detection Configuration

The automated cruise control system configuration 300 as shown in FIG. 3 also includes a ground vehicle control detector 335 that detects a brake pedal 345 of the ground vehicle 110, an accelerator pedal 355 of the ground vehicle 110, automatic cruise control (ACC) switches 365 of the ground vehicle 110, and a steering angle sensor 375 of the ground vehicle 110. The ground vehicle control detector 335 may detect driving parameters associated with the control of the ground vehicle 110 as the ground vehicle 110 operates. The energy consumption cruise controller 320 may then incorporate the driving parameters into the automatic adjustment of the ground vehicle 110 as the ground vehicle 110 operates. In doing so, the energy consumption cruise controller 320 may adjust the vehicle systems 390 of the ground vehicle 110.

The ground vehicle control detector 335 detects a plurality of ground vehicle control inputs, such as but not limited inputs generated from the brake pedal 345, accelerator pedal 355, ACC switches 365, steering angle sensor 375, the clutch, and so on, that are associated with an operation of the ground vehicle 110 as the ground vehicle 110 maneuvers along the segment of the roadway. The ground vehicle control inputs are generated from a longitudinal operation of the ground vehicle 110. The ground vehicle control inputs provide insight to the energy consumption cruise controller 320 as to the state of the control of the ground vehicle 110 in real-time as well as the intent of the driver with regard to operating the ground vehicle 110 in real-time. The energy consumption cruise controller 320 may then incorporate the ground vehicle control inputs into the automatic adjustment of the operation of the ground vehicle 110 to account for the current state of the control of the ground vehicle 110 as well as the intent of the driver with regard to operating the ground vehicle 110.

For example, the ground vehicle control inputs provide insight as to the current state of the control of the ground vehicle 110 as well as the intent of the driver such as but not limited to the deceleration and/or braking of the ground vehicle 110 based on the brake pedal 345, the acceleration and/or increase in operating speed of the ground vehicle 110 based on the accelerator pedal 355, the current status of the ACC based on the ACC switches 365 and/or any other type of ground vehicle control input that is indicative as to the current state of the operation of the ground vehicle 110 and/or the intent of the driver that will be apparent to those skilled in the relevant art(s) without departing from the spirit and scope of the disclosure.

The energy consumption cruise controller 320 may then automatically adjust the operation of the ground vehicle 110 as the ground vehicle 110 maneuvers along the segment of the roadway to maintain the operation of the ground vehicle 110 within the operation threshold based on the detected ground vehicle control inputs. Each of the ground vehicle control inputs detected by the ground vehicle control detector 335 may enable the energy consumption cruise controller 320 to automatically adjust the operation of the ground vehicle 110 to accommodate for the current state of the operation of the ground vehicle 110 as well as the driver intent in real-time.

The energy consumption cruise controller 320 may identify each ground vehicle control input as detected by the ground vehicle control detector 335 in real-time as the ground vehicle 110 maneuvers along the segment of the roadway. The energy consumption cruise controller 320 may determine a current state of the operation of the ground vehicle 110 and a driver intent from each ground vehicle control input as the ground vehicle 110 is operating in real-time. The current state of the operation of the ground vehicle 110 is indicative as to a current position of the ground vehicle 110 as the ground vehicle 110 is operating in real-time and the driver intent is an intent that the driver requests to operate the ground vehicle 110 in real-time. The energy consumption cruise controller 320 may then automatically adjust the operation of the ground vehicle 110 as the ground vehicle 110 maneuvers along the segment of the roadway to accommodate for the current state of the operation of the ground vehicle 110 and the driver intent of the ground vehicle 110 in real-time.

Rather than ignore the current state of the operation of the ground vehicle 110 as well as the driver intent, energy consumption cruise controller 320 may identify each ground vehicle control input and the corresponding state of the ground vehicle 110 based on each ground vehicle control input and then automatically adjust the operation of the ground vehicle 110 based on the current state of the ground vehicle 110 and the driver intent. For example, the vehicle systems 390 may include but are not limited to the engine controller, brakes, steering, throttle, and/or any other type of system of the ground vehicle 110 that trigger the ground vehicle 110 to operate.

For example, the current status of the brake pedal 345 in real-time as the ground vehicle 110 maneuvers along the segment of the segment of the roadway may indicate to the energy consumption cruise controller 320 as to whether the ground vehicle 110 is currently braking and thereby decelerating. The energy consumption cruise controller 320 may determine that the ground vehicle 110 is not currently in the braking status when there is no pressure applied to the brake pedal 345. In doing so, the energy consumption cruise controller 320 may automatically adjust the operation of the ground vehicle 110 as the ground vehicle maneuvers along the segment of the roadway based on the assumption that the ground vehicle 110 is not currently braking. The energy consumption cruise controller 320 may freely increase the operating speed of the ground vehicle 110 when appropriate without any concern that the ground vehicle is currently braking. Further, the energy consumption cruise controller 320 may further emphasize a decrease in the in the operating speed of the ground vehicle 110 knowing that the ground vehicle 110 is not currently braking when decreasing the operating speed of the ground vehicle 110 when appropriate.

Further, the energy consumption cruise controller 320 may determine that the ground vehicle 110 is currently in the braking status when there is pressure applied to the brake pedal 345. In doing so, the energy consumption cruise controller 320 may automatically adjust the operation of the ground vehicle 110 as the ground vehicle 110 maneuvers along the segment of the roadway based on the assumption that the ground vehicle 110 is currently braking. The energy consumption cruise controller 320 may freely decrease the operating speed of the ground vehicle 110 when appropriate without any concern that the ground vehicle 110 is currently being accelerated via the accelerator pedal 355. Further, the energy consumption cruise controller 320 may further emphasize an increase in the operating speed of the ground vehicle 110 knowing that the ground vehicle 110 is currently breaking when increasing the operating speed of the ground vehicle 110 when appropriate.

However, the energy consumption cruise controller 320 may be overridden by the intent of the driver with regard to the driver requesting a decrease in the operating speed based on the driver applying pressure to the brake pedal 345. The energy consumption cruise controller 320 may determine that the operating speed is to be increased and/or maintained in order to decrease the overall energy consumption of the ground vehicle 110 as the ground vehicle 110 maneuvers along the segment of the roadway. For example, the energy consumption cruise controller 320 may automatically increase the ground vehicle 110 as the ground vehicle 110 declines from the top grade 230b of the segment of the roadway to decrease the overall energy consumption of the ground vehicle 110. However, the driver may not feel comfortable operating the vehicle at the increased speed as automatically adjusted by the energy consumption cruise controller 320. The driver may further apply pressure to the brake pedal 345 with the intent of decreasing the operating speed of the ground vehicle 110. In doing so, the driver may override the energy consumption cruise controller 320 and the energy consumption cruise controller 320 may automatically concede to the driver with regard to the intent of the driver to decrease the speed of the ground vehicle 110.

In another example, the current status of the accelerator pedal 355 in real-time as the ground vehicle 110 maneuvers along the segment of the roadway may indicate to the energy consumption cruise controller 320 as to whether the ground vehicle 110 is currently accelerating due to the driver applying pressure to the accelerator pedal 355. The energy consumption cruise controller 320 may determine that the ground vehicle is not currently in the accelerating status when there is no pressure applied to the accelerator pedal 355. In doing so, the energy consumption cruise controller 320 may automatically adjust the operation of the ground vehicle 110 as the ground vehicle 110 maneuvers along the segment of the roadway based on the assumption that the ground vehicle 110 is not currently accelerating. The energy consumption cruise controller 320 may freely decrease the operating speed of the ground vehicle 110 when appropriate without any concern that the ground vehicle 110 is currently accelerating. Further, energy consumption cruise controller 320 may further emphasize an increase in the operating speed of the ground vehicle 110 knowing that the ground vehicle 110 is not currently accelerating when increasing the operating speed of the ground vehicle 110 when appropriate.

Further, the energy consumption cruise controller 320 may determine that the ground vehicle 110 is currently in the acceleration status when there is pressure applied to the accelerator pedal 355. In doing so, the energy consumption cruise controller 320 may automatically adjust the operation of the ground vehicle 110 as the ground vehicle 110 maneuvers along the segment of the roadway based on the assumption that the ground vehicle 110 is currently accelerating. The energy consumption cruise controller 320 may freely increase the operating speed of the ground vehicle 110 when appropriate without any concern that the ground vehicle 110 is currently braking via the brake pedal 345. Further, energy consumption cruise controller 320 may further emphasize a decrease in the operating speed of the ground vehicle 110 knowing that the ground vehicle 110 is currently accelerating when decreasing the operating speed of the ground vehicle 110 when appropriate.

However, the energy consumption cruise controller 320 may be overridden by the intent of the driver with regard to the driver requesting an increase in the operating speed based on the driver applying pressure to the accelerator pedal 355. The energy consumption cruise controller 320 may determine that the operating is to be decreased and/or maintained in order to decrease the overall energy consumption of the ground vehicle 110 as the ground vehicle 110 maneuvers along the segment of the roadway.

For example, the energy consumption cruise controller 320 may determine that the operating speed is to be decreased and/or maintained in order to decrease the overall energy consumption of the ground vehicle 110 as the ground vehicle maneuvers along the segment of the roadway. However, the driver may be attempting to accelerate quickly to speed across railroad tracks and is not interested in decreasing energy consumption but simply desires to move over the railroad tracks quickly. The driver may further apply pressure to the accelerator pedal 355 with the intent of increasing the operating speed of the ground vehicle 110. In doing so, the driver may override the energy consumption cruise controller 320 and the energy consumption cruise controller 320 may automatically concede to the driver with regard to the intent of the driver to increase the operating speed of the ground vehicle 110. The ground vehicle control detector 335 may detect and provide any type of ground vehicle control input to the energy consumption cruise controller 320 that may enable the energy consumption cruise controller 320 to automatically adjust the operation of the ground vehicle 110 to account for the impact of the ground vehicle control input detected by the ground vehicle control detector 335 that will be apparent to those skilled in the relevant art(s) without departing from the spirit and scope of the disclosure.

### Vehicle Load Estimator Configuration

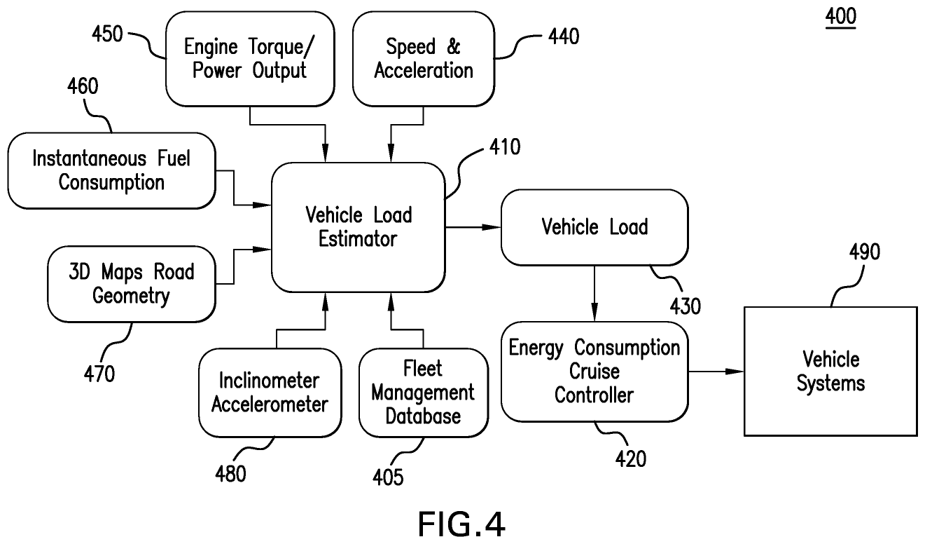

FIG. 4 illustrates a block diagram of an automated cruise control system that automatically decreases the overall energy consumption of the ground vehicle as the ground vehicle operates on a roadway based on the vehicle load of the ground vehicle. An automated cruise control system 400 includes a vehicle load estimator 410 that determines an estimated load 430 of the ground vehicle 110 in real-time based on a plurality of vehicle load parameters. The vehicle load parameters include but are not limited to speed/acceleration 440 of the ground vehicle 110, engine torque/output power 450 of the ground vehicle 110, instantaneous energy consumption 460 of the ground vehicle 110, 3D maps road geometry 470 of the segment of the roadway, inclinometer/accelerometer 480, and a fleet management database 405. The vehicle load estimator 410 detects the vehicle load parameters as the ground vehicle 110 operates. The energy consumption cruise controller 420 may then incorporate the estimated vehicle load 430 into the automatic adjustment of the ground vehicle 110 as the ground vehicle 110 operates. In doing so, the energy consumption cruise controller 420 may adjust the vehicle systems 390 of the ground vehicle 110. The automated cruise control configuration 400 shares many similar features with the automated cruise control configuration 100 and the automated cruise control configuration 300; therefore, only the differences between the automated cruise control configuration 400 and the automated cruise control configuration 100 and the automated cruise control configuration 300 are to be discussed in further detail.

The vehicle load estimator 410 detects a plurality of vehicle load parameters that is associated with a vehicle load 430 of the ground vehicle 110 as the ground vehicle 110 maneuvers along the segment of the roadway. The vehicle load parameters are generated from the longitudinal operation of the ground vehicle 110 as the ground vehicle 110 reacts to the vehicle load 430 as the ground vehicle 110 maneuvers along the segment of the roadway and from a 3D geometry 470 of the segment of the roadway. The vehicle load estimator 410 then determines an estimated load 430 of the ground vehicle 110 in real-time as the ground vehicle 110 maneuvers along the segment of the roadway based on the vehicle load parameters detected in real-time. The estimated load 430 impacts the operation of the ground vehicle 110 in real-time as the ground vehicle 110 maneuvers along the segment of the roadway. The estimated load 430 provides insight to the energy consumption cruise controller 420 as to the vehicle load 430 of the ground vehicle 110 in real-time such that the energy consumption cruise controller 420 may then incorporate the driving parameters into the automatic adjustment of the operation of the ground vehicle 110 to account for the current vehicle load 430 of the ground vehicle 110 as the ground vehicle 110 maneuvers along the segment of the roadway.

The energy consumption cruise controller 420 may then automatically adjust the operation of the ground vehicle 110 as the ground vehicle 110 maneuvers along the segment of the roadway to maintain the operation of the ground vehicle 110 within the operation threshold based on the estimated load 430 of the ground vehicle 110 determined in real-time. The estimated load 430 of the ground vehicle 110 impacts the amount of overall energy consumption of the ground vehicle 110 as the ground vehicle 110 operates along the segment of the roadway in real-time.

Rather than simply having the ground vehicle 110 operate at the set speed, the vehicle load estimator 410 may determine the estimated load 430 of the ground vehicle 110 in real-time. The energy consumption cruise controller 420 may then determine the impact of the estimated load 430 of the ground vehicle 110 to the operation of the ground vehicle 110 relative to the segment of the roadway that the ground vehicle 110 is currently maneuvering. The energy consumption cruise controller 420 may then automatically adjust the operation of the ground vehicle 110 based on the estimated load 430 of the ground vehicle 110 relative to the 3D geometry 470 of the segment of the roadway that the ground vehicle 110 is currently maneuvering in real-time.

Each of the vehicle load parameters detected by the vehicle load estimator 410 may provide insight as to the current estimated load 430 of the ground vehicle 110. The estimated load 430 of the ground vehicle 110 may significantly impact how the energy consumption cruise controller 420 determines how to automatically adjust the ground vehicle 110 to maneuver along the segment of the roadway. For example, the acceleration and/or deceleration of the ground vehicle 110 relative to the 3D geometry 470 of the segment of the roadway may be significantly impacted by the vehicle load 430 of the ground vehicle 110 as the ground vehicle 110 engages the segment of the roadway. The energy consumption cruise controller 420 may automatically adjust a fully loaded semi-truck and trailer to accelerate and/or decelerate over longer periods of time due to the fully loaded semi-truck and trailer as compared to a similar semi-truck and trailer that is empty. The energy consumption cruise controller 420 may automatically adjust the empty semi-truck and trailer to accelerate and/or decelerate over shorter periods of time due to the significantly decreased load as compared to the fully loaded semi-truck and trailer.

In another example, how the energy consumption cruise controller 420 automatically adjusts the operation of the ground vehicle 110 relative to segments of the roadway with more extreme 3D geometry 470, such as the curvature 280b, may be significantly impacted by the vehicle load 430 of the ground vehicle 110 as the ground vehicle 110 engages the segment of the roadway with more extreme 3D geometry 470. The energy consumption cruise controller 420 may automatically adjust a fully loaded semi-truck and trailer to decelerate further and operate at the lower limit 255b of the longitudinal speed threshold when maneuvering through the curvature 280b as compared to a similar semi-truck and trailer that is empty. The energy consumption cruise controller 420 may automatically adjust the empty semi-truck and trailer to decelerate at a faster rate while operate at a higher operating speed when maneuvering through the curvature 280b due to the significantly decreased load as compared to the fully loaded semi-truck and trailer.

The vehicle load estimator 410 detects a speed/acceleration vehicle load parameter 440 associated with the vehicle load 430 of the ground vehicle 110 in real-time as the ground vehicle 110 maneuvers along the segment of the roadway. The speed/acceleration vehicle load parameter 440 is indicative as to the vehicle load 430 of the ground vehicle 110 in real-time as the speed/acceleration vehicle load parameter 440 varies in real-time as the ground vehicle 110 maneuvers along the segment of the roadway in real-time. The vehicle load estimator 40 determines the estimated load of the ground vehicle 110 in real-time as the ground vehicle 110 maneuvers along the segment of the roadway based on the speed/acceleration vehicle load parameter 440 detected in real-time. An increased speed/acceleration vehicle load parameter 440 corresponds to an increased vehicle load of the ground vehicle 110.

The vehicle load estimator 410 may incorporate the speed/acceleration vehicle load parameter 440 into the determination of the vehicle load 430 in real-time. The speed/acceleration 440 of the ground vehicle 110 in real-time is indicative to the vehicle load 430 of the ground vehicle 110. An increased speed/acceleration 440 of the ground vehicle 110 as the ground vehicle 110 is maneuvering along the segment of the roadway in real-time may be indicative that an increased vehicle load 430 is positioned on the ground vehicle 110 relative to the 3D geometry 470 of the segment of roadway. For example, as the fully loaded semi-truck and trailer is coming down from the top grade 230b to the flat grade 230c of the 3D geometry 470 of the segment of the roadway, the fully loaded semi-truck and trailer may have a significantly increased speed/acceleration 440 due to the fully loaded semi-truck and trailer as opposed to an empty semi-truck and trailer.

The energy consumption cruise controller 420 may then automatically adjust the operation of the ground vehicle 110 in real-time as the ground vehicle 110 maneuvers along the segment of the roadway to accommodate for the speed/acceleration vehicle load parameter 440 as the speed/acceleration vehicle load parameter 440 varies in real-time thereby impacting the vehicle load 430 of the ground vehicle 110 in real-time to maintain the operation of the ground vehicle 110 within the operation threshold of the segment of the roadway.

The vehicle load estimator 410 may incorporate the engine torque/power output vehicle load parameter 450 of the ground vehicle 110 into the determination of the vehicle load 430 in real-time. The engine torque/power output 450 is indicative to the vehicle load 430 of the ground vehicle 110. An increased engine torque/power output 450 of the ground vehicle as the ground vehicle 110 is maneuvering along the segment of the roadway in real-time may be indicative that an increased vehicle load 430 is positioned on the ground vehicle 110 relative to the 3D geometry 470 of the segment of the roadway. For example, as the fully loaded semi-truck and trailer is climbing from the flat grade 230a to the top grade 230b of the 3D geometry 470 of the segment of the roadway, the fully loaded semi-truck and trailer may have a significantly increased engine torque/power output 450 due to the fully loaded semi-truck and trailer as opposed to an empty semi-truck and trailer.

The vehicle load estimator 410 may incorporate the instantaneous energy consumption vehicle load parameter 460 of the ground vehicle 110 into the determination of the vehicle load 430 in real-time. An increased instantaneous energy consumption 460 of the ground vehicle 110 as the ground vehicle 110 is maneuvering along the segment of the roadway in real-time may be indicative that an increased vehicle load 430 is positioned on the ground vehicle 110 relative to the 3D geometry 470 of the segment of the roadway. For example, as the fully loaded semi-truck and trailer is climbing from the flat grade 230a to the top grade 230b of the 3D geometry 470 of the segment of the roadway, the fully loaded semi-truck and trailer may have a significantly increased instantaneous energy consumption 460 due to the fully loaded semi-truck and trailer as opposed to an empty semi-truck and trailer.

The vehicle load estimator 410 may also incorporate the 3D maps of the roadway geometry vehicle load parameter 470 into the determination of the vehicle load 430 in real-time. As discussed in detail above, the energy consumption cruise controller 420 may automatically adjust the operation of the ground vehicle 110 based on the 3D geometry 470 of the segment of the roadway. The vehicle load 430 of the ground vehicle 110 may significantly impact how the energy consumption cruise controller 420 automatically adjusts the operation of the ground vehicle 110 relative to the 3D geometry 470 of the segment of the roadway. As the energy consumption cruise controller 420 may adjust the operation of the fully loaded semi-truck and trailer significantly different than the empty semi-truck and trailer especially when maneuvering throughout more segments of the roadway with more extreme 3D geometries 470.

However, the 3D geometry 470 of the segment of the roadway may also impact the vehicle load 430 in real-time. As the ground vehicle 110 maneuvers along different segments of the roadway the differences in 3D geometry 470 of the different segments may impact the vehicle load 430 in real-time differently. For example, the fully loaded semi-truck and trailer that is transitioning down from the top grade 230b to the flat grade 230c may significantly increase the speed/acceleration 440, the engine torque/power output 450, instantaneous energy consumption 460 and so on based on the fully loaded semi-truck and trailer significantly impacting the fully loaded semi-truck and trailer as the fully loaded semi-truck and trailer transitions down from the top grade 230b. In doing so, the vehicle load estimator 410 may determine an increased vehicle load 430 for the segment of the roadway with the 3D geometry 470 of the change in grade.

However, the same fully loaded semi-truck and trailer that is maneuvering along a significantly long segment of the roadway with a flat grade and no curvatures may have a decrease in the speed/acceleration 440, the engine torque/power output 450, instantaneous energy consumption 460 and so on based on the fully loaded semi-truck and trailer having a significantly less impact as the fully loaded semi-truck and trailer maneuvers along the flat grade with no curvatures. In doing so, the vehicle load estimator 410 may determine a decreased vehicle load 430 for the segment of the roadway with the 3D geometry 470 of the limited change in grade and no curvature compared to the 3D geometry 470 of the change in grade.

Thus, the vehicle load estimator 410 may determine the vehicle load 430 of the ground vehicle 110 based on the vehicle load parameters in real-time and may do so relative to the 3D geometry 470 of the segment of the roadway that the ground vehicle is maneuvering in real-time. In doing so, the energy consumption cruise controller 420 may automatically adjust the operation of the ground vehicle 110 in real-time based on the vehicle load 430 of the ground vehicle 110 in real-time. The vehicle load estimator 410 may detect any type of vehicle load parameter and incorporate any type of vehicle load parameter into the determination of the vehicle load 430 in real-time that may enable the energy consumption cruise controller 320 to automatically adjust the operation of the ground vehicle 110 to account for the vehicle load 430 of the ground vehicle that will be apparent to those skilled in the relevant art(s) without departing from the spirit and scope of the disclosure.

The vehicle load estimator 410 may be a device that is capable of electronically communicating with other devices. Examples of the vehicle load estimator 410 may include a mobile telephone, a smartphone, a workstation, a portable computing device, other computing devices such as a laptop, or a desktop computer, cluster of computers, set-top box, and/or any other suitable electronic device that will be apparent to those skilled in the relevant art(s) without departing from the spirit and scope of the disclosure.

In an embodiment, multiple modules may be implemented on the same computing device. Such a computing device may include software, firmware, hardware or a combination thereof. Software may include one or more applications on an operating system. Hardware can include, but is not limited to, a processor, a memory, and/or graphical user interface display.

### Risk Estimator Configuration

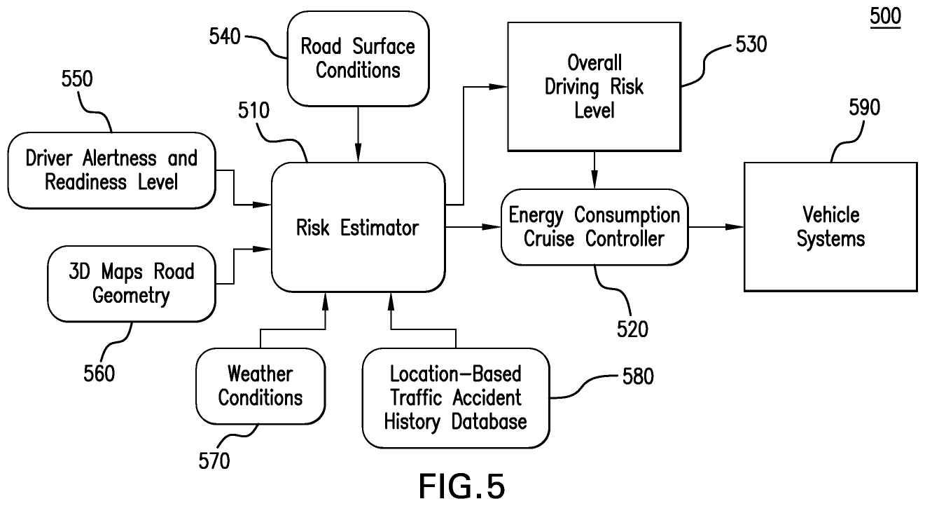

FIG. 5 illustrates a block diagram of an automated cruise control system that automatically decreases the overall energy consumption of the ground vehicle as the ground vehicle operates on a roadway based on an overall driving risk level of the ground vehicle 110. An automated cruise control configuration 500 includes a risk estimator 510 that determines an overall driving risk level 530 of the ground vehicle 110 in real-time based on a plurality of driving risk conditions. The driving risk conditions include but are not limited to road surface conditions 540, driver alertness and readiness level 550, 3D maps road geometry 560, weather conditions 570, location-based traffic accident history database 580 and so on. The risk estimator 510 detects the driving risk conditions as the ground vehicle 110 operates throughout the driving environment of the segment of the roadway. In doing so, the energy consumption cruise controller 520 may adjust the vehicule systems 390 of the ground vehicle 110. The automated cruise control configuration 500 shares may similar features with the automated cruise control configuration 100, the automated cruise control configuration 300, and the automated cruise control configuration 400; therefore, only the differences between the automated cruise control configuration 500 and the automated cruise control configuration 100, the automated cruise control configuration 200, and the automated cruise control configuration 300 are to be discussed in further detail.

The risk estimator 520 detects a plurality of driving risk conditions associated with the driving environment of the ground vehicle 110 in real-time as the ground vehicle 110 maneuvers along the segment of the roadway. The driving risk conditions are generated from the driving environment of the segment of the roadway that the ground vehicle 110 is operating in real-time and a driver status of a driver of the ground vehicle 110 that is indicative of an engagement of the driver in operating the ground vehicle in real-time. The risk estimator 510 then determines an overall driving risk level 530 for the ground vehicle 110 as the ground vehicle 110 maneuvers along the segment of the roadway based on the driving risk conditions detected in real-time. The overall driving risk level 530 impacts the operation of the ground vehicle 110 in real-time as the ground vehicle 110 maneuvers along the segment of the roadway. The overall driving risk level 530 provides insight to the energy consumption cruise controller 520 as to the overall risk driving level 530 of the ground vehicle 110 in real-time such that the energy consumption cruise controller 520 may then incorporate the driving risk conditions into the automatic adjustment of the ground vehicle 110 to account for the current overall risk driving level 530 of the ground vehicle 110 as the ground vehicle 110 maneuvers along the segment of the roadway.

The energy consumption cruise controller 530 may then automatically adjust the operation of the ground vehicle 110 as the ground vehicle 110 maneuvers along the segment of the roadway to maintain the operation of the ground vehicle within the operation threshold based on the overall driving risk level 530 of the ground vehicle 110 in real-time. The overall driving risk level 530 for the ground vehicle 110 impacts the amount of overall energy consumption of the ground vehicle 110 as the ground vehicle 110 operates along the segment of the roadway in real-time.

Rather than simply having the ground vehicle 110 operate at the set speed, the risk estimator 510 may determine the overall driving risk level 50 of the ground vehicle in real-time. The energy consumption cruise controller 520 may then determine the impact of the overall driving risk level 530 of the ground vehicle to the operation of the ground vehicle 110 relative to the segment of the roadway that the ground vehicle is currently maneuvering. The energy consumption cruise controller 520 may then automatically adjust the operation of the ground vehicle 110 based on the overall risk driving level 530 of the ground vehicle 110 relative to the driving risk conditions of the driving environment and the driver status of the driver impacting how the ground vehicle 110 is currently maneuvering along the segment of the roadway in real-time.

Each of the driving risk conditions detected by the risk estimator 510 may provide insight as to the overall driving risk level 530 of the ground vehicle 110. The overall driving risk level 530 of the ground vehicle 110 may significantly impact how the energy consumption cruise controller 520 determines how to automatically adjust the ground vehicle 110 to maneuver along the segment of the roadway. For example, the driver performance data for the driver may significantly impact how the energy consumption cruise controller 520 determines how to automatically adjust the ground vehicle 110 to maneuver along the segment of the roadway. The driver performance data may be the data acquired from the operation of the ground vehicle 110 by the driver. The driver performance data may be indicative as to the quality and/or habits of the driver as the driver operates the ground vehicle 110. The driver performance data may also include past traffic violations and/or accidents that the driver has engaged. The energy consumption cruise controller 520 may automatically adjust the operation of the ground vehicle 110 for a driver with poor performance driver data differently than the for a driver with positive performance driver data.

In another example, how the energy consumption cruise controller 420 automatically adjusts the operation of the ground vehicle 110 relative to the overall risk of the segments of the roadway with more extreme 3D geometry 570, such as a curvature 280b, as well as a fully loaded ground vehicle 110 may be significantly impacted as the ground vehicle 110 engages the segment of the roadway with more extreme 3D geometry 570 and a full load. The energy consumption cruise controller 520 may automatically adjust a fully loaded semi-truck and trailer that is engaging the curvature 280b differently than an empty semi-truck and trailer that is engaging a flat grade and no curvature segment of the roadway.

The risk estimator 540 may incorporate the road surface driving risk conditions 540 into the determination of the overall driving risk level 530 in real-time. As discussed above in detail, the road surface conditions 540 may be monitored and provided to the energy consumption cruise controller 520. The road surface conditions 540 of the ground vehicle 110 in real-time is indicative to the overall driving risk level 530 of the ground vehicle 110. An increased intensity in road surface conditions 540 as the ground vehicle 110 is maneuvering along the segment of the roadway in real-time may be indicative that an increased overall driving risk level 530 is associated with the ground vehicle 110 as the ground vehicle 110 maneuvers along the segment of the roadway. For example, as the fully loaded semi-truck and trailer is coming down from the top grade 230b to the flat grade 230c of the 3D geometry 570 of the segment of the roadway with icy road conditions, the fully loaded semi-truck and trailer travelling down the top grade 230b with icy road conditions may have a significantly increased overall driving risk level 530 due to the icy road conditions as opposed to dry road conditions.

The risk estimator 510 may incorporate the weather driving risk conditions 570 into the determination of the overall driving risk level 530 in real-time. As discussed above in detail, the weather conditions 570 may be monitored and provided to the energy consumption cruise controller 520. The weather conditions 570 of the ground vehicle 110 in real-time is indicative to the overall driving risk level 530 of the ground vehicle 110. An increased intensity in the weather conditions 570 as the ground vehicle 110 is maneuvering along the segment of the roadway in real-time may be indicative that an increased overall driving risk level 530 is associated with the ground vehicle 110 as the ground vehicle 110 maneuvers along the segment of the roadway. For example, as the fully loaded semi-truck and trailer is coming down from the top grade 230b to the flat grade 230c of the 3D geometry 570 of the segment of the roadway with snowy weather conditions, the fully loaded semi-truck and trailer travelling down the top grade 230b with icy road conditions may have a significantly increased overall driving risk level 530 due to the snowy weather conditions as opposed to dry weather conditions.

The risk estimator 510 may incorporate the location-based traffic accident driving risk condition 580 of the segment of the roadway that the ground vehicle 110 is maneuvering into the determination of the overall driving risk level 530 in real-time. An increased traffic condition 580 of the segment of the roadway that the ground vehicle 110 is maneuvering in real-time may be indicative that an increased overall driving risk level 530 is associated with the ground vehicle 110 as the ground vehicle 110 maneuvers along the segment of the roadway. For example, as the fully loaded semi-truck and trailer is coming down from the top grade 230b to the flat grade 230c of the 3D geometry 570 of the segment of the roadway with an increased traffic condition 580, the fully loaded semi-truck and trailer travelling down from the top grade 230b with the increased traffic condition 580 may have a significantly increased overall driving risk level 530 due to the increased traffic condition 580 as opposed to no traffic conditions.

The risk estimator 530 may also incorporate the 3D maps of the roadway geometry vehicle load parameter 570 into the determination of the overall driving risk level 530 in real-time. As discussed in detail above, the energy consumption cruise controller 520 may automatically adjust the operation of the ground vehicle 110 based on the 3D geometry 570 of the segment of the roadway. The overall driving risk 530 of the ground vehicle 110 may significantly impact how the energy consumption cruise controller 520 automatically adjusts the operation of the ground vehicle 110 relative to the 3D geometry 570 of the segment of the roadway. As the energy consumption cruise controller 520 may adjust the operation of the fully loaded semi-truck and trailer significantly different than the empty semi-truck and trailer especially when maneuvering throughout more segments of the roadway with more extreme 3D geometries 570.

The risk estimator 530 may also incorporate the driver alertness and readiness level driving risk condition 550 for the driver as the driver maneuvers the ground vehicle 110 along the segment of the roadway into the determination of the overall driving risk level 530 in real-time. The driver monitoring camera 385 may capture the head and the body of the driver in real-time as the driver maneuvers the ground vehicle 110 along the segment of the roadway. The energy consumption cruise controller 520 may then identify the driver from the image captured by the driver monitoring camera 385 of the driver. As the driver continues to maneuver the ground vehicle 110 along the segment of the roadway, the driver monitoring camera 385 may continuously capture driver characteristics of the driver in real-time. The driver characteristics may be indicative as to an alertness and/or readiness level of the driver with regard to the driver adequately maneuvering the ground vehicle 110 along the segment.

For example, the driver characteristics may indicate that the driver is operating an alert level such that the driver is alert and cognizant of the driving environment of the segment of the roadway as well as the ground vehicle 110 itself that the driver is maneuvering along the segment of the roadway. However, the driver characteristics may also indicate that the driver is operating at a non-readiness level such that the driver is failing to be alert and/or cognizant of the driving environment of the segment of the roadway.

For example, the driver characteristics may indicate that the driver is failing to be alert such that the driver characteristics may indicate that the driver is drowsy and/or falling asleep while operating the ground vehicle 110. In another example, the driver characteristics may indicate that the driver is distracted such that driver characteristics is operating his smartphone while operating the ground vehicle 110. The driving characteristics that may be monitored by the driver monitoring camera 385 and evaluated by the energy consumption cruise controller 520 may include but are not limited to the distraction of the driver, drowsiness, of the driver, eye gaze of the driver, emotion of the driver, head-tilt of the driver, the face of the driver, gaze angle of the driver, blink rates of the driver, hands position of the driver, body position of the driver, head position of the driver, temperature of the driver, heartrate of the driver, respiration rates of the driver, and/or any other driver characteristic that may be indicative as to the driver alertness and readiness level driving risk condition 550 that will be apparent to those skilled in the relevant art(s) without departing from the spirit and scope of the disclosure.

The risk estimator 510 may then determine the alertness and readiness level driving risk condition 550 based on the driver characteristics detected by the driver monitoring camera 385. For example, the driver monitoring camera 385 may continuously monitor the head position of the driver as the driver operates the ground vehicle 110. The risk estimator 510 may be monitoring head position of the driver to determine if the head position of the driver deviates from a head tilt angle threshold. The head tilt angle threshold may be the threshold for the head tilt angle of the head of the driver that if deviates greater than the head tilt angle threshold from the head tilt angle of the head of the driver that is associated with the head of the driver being at a head tilt angle of 0 degrees for a period of time, then the risk estimator 510 may determine that the driver is falling asleep and may alert the driver. For example, the risk estimator 510 may monitor the head tilt angle of the driver to determine if the head tilt angle of the head of the driver deviates greater than 25 degrees for longer than 5 seconds. The risk estimator 510 may then determine that the driver is falling asleep when the head tilt angle of the driver deviates greater than 25 degrees for longer than 5 seconds and may alert the driver.

The risk estimator 510 may incorporate the driver alertness and readiness level driving risk condition 550 of the segment of the roadway that the ground vehicle 110 is maneuvering into the determination of the overall driving risk level 530 in real-time. A driver alertness and readiness driving risk condition 550 that is indicative that the driver is at a decreased level of alertness and/or readiness as the driver is maneuvering the ground vehicle 110 along the segment of the roadway may be indicative of an increased overall driving risk level 530 is associated with the ground vehicle 110 as the driver maneuvers the ground vehicle 110 along the segment of the roadway. For example, the driver that has the driver characteristic of an increased blink rate above a blink rate threshold is indicative that the driver is fighting drowsiness and that the alertness level of the driver may be decreasing. Such a driver may have a significantly increased overall driving risk level 530 due to the significant decrease in alertness level due to the increased blink rate of the driver as opposed to the driver who is alert and has a normal blink rate.

Thus, the risk estimator 510 may determine the overall driving risk level 530 of the ground vehicle 110 based on the driving risk conditions in real-time and may do so relative driving environment of the segment of the roadway as well as the driver status of the driver with regard to the driver engaging the operating of the ground vehicle in real-time. In doing so, the energy consumption controller 420 may automatically adjust the operation of the ground vehicle 110 in real-time based on the overall driving risk level 530 of the ground vehicle 110 in real-time. The risk estimator 510 may detect any type of driving risk condition and incorporate any type of driving risk condition into the determination of the overall driving risk level 530 in real-time that may enable the energy consumption cruise controller 520 to automatically adjust the operation of the ground vehicle 110 to account for the overall driving risk level 530 of the ground vehicle 110 that will be apparent to those skilled in the relevant art(s) without departing from the spirit and scope of the disclosure.

The risk estimator 510 may be a device that is capable of electronically communicating with other devices. Examples of the risk estimator 510 may include a mobile telephone, a smartphone, a workstation, a portable computing device, other computing devices such as a laptop, or a desktop computer, cluster of computers, set-top box, and/or any other suitable electronic device that will be apparent to those skilled in the relevant art(s) without departing from the spirit and scope of the disclosure.

In an embodiment, multiple modules may be implemented on the same computing device. Such a computing device may include software, firmware, hardware or a combination thereof. Software may include one or more applications on an operating system. Hardware can include, but is not limited to, a processor, a memory, and/or graphical user interface display.

### CONCLUSION

It is to be appreciated that the Detailed Description section, and not the Abstract section, is intended to be used to interpret the claims. The Abstract section may set forth one or more, but not all exemplary embodiments, of the present disclosure, and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) the various changes in form and detail can be made without departing from the spirt and scope of the present disclosure. Thus the present disclosure should not be limited by any of the above-described exemplary embodiments, but should be defined only in accordance with the following claims and their equivalents.

What is claimed is:

1. An automated cruise control system to automatically decrease overall energy consumption, comprising:
a plurality of sensors associated with a ground vehicle that maneuvers on a roadway that is configured to detect a plurality of driving parameters associated with the ground vehicle as the ground vehicle maneuvers along a segment of the roadway, wherein the driving parameters are indicative to a driving environment that the ground vehicle is operating;
a ground vehicle control detector associated with the ground vehicle that is configured to detect a plurality of ground vehicle control inputs associated with an operation of the ground vehicle as the ground vehicle maneuvers along the segment of the roadway, wherein the ground vehicle control inputs are generated from a longitudinal operation of the ground vehicle; and
a energy consumption cruise controller configured to automatically adjust the operation of the ground vehicle as the ground vehicle maneuvers along the segment of the roadway to maintain the operation of the ground vehicle within an operation threshold based on the detected driving parameters and ground vehicle control inputs, wherein the operation threshold is the operation of the ground vehicle that decreases an amount of overall energy consumption by the ground vehicle and maintains a longitudinal speed of the ground vehicle within a longitudinal speed threshold associated with the segment of the roadway.

2. The automated cruise control system of claim 1, wherein the plurality of sensors further comprise:
a plurality of visual detection devices configured to detect a plurality of visual detection driving parameters that are associated with the ground vehicle as the ground vehicle maneuvers along the segment of the roadway, wherein the visual detection driving parameters are driving parameters that are visually identifiable as detected by the visual detection devices and are indicative to the driving environment that the ground vehicle is operating.

3. The automated cruise control system of claim 2, wherein the energy consumption cruise controller is further configured to:
identify the visual detection driving parameters as detected by the visual detection devices in real-time as the ground vehicle maneuvers along the segment of the roadway;
determine an impact that each of the visual detection driving parameters are having on the driving environment that the ground vehicle is operating in real-time; and
automatically adjust the operation of the ground vehicle as the ground vehicle maneuvers along the segment of the roadway to maintain the operation of the ground vehicle within the operation threshold to accommodate for each of the visual detection driving parameters as each visual detection driving parameter impacts the driving environment that the ground vehicle is operating in real-time.

4. The automated cruise control system of claim 1, wherein the energy consumption cruise controller is further configured to:
identify each ground vehicle control input as detected by the ground vehicle control detector in real-time as the ground vehicle maneuvers along the segment of the roadway;
determine a current state of operation of the ground vehicle and a driver intent from each ground vehicle control input as the ground vehicle is operating in real-time, wherein the current state of the operation of the ground vehicle is indicative as to a current operation of the ground vehicle as the ground vehicle is operating in real-time and the driver intent is an intent that the driver requests to operate the ground vehicle in real-time; and
automatically adjust the operation of the ground vehicle as the ground vehicle maneuvers along the segment of the roadway to accommodate for the current state of the operation of the ground vehicle and the driver intent of the driver of the ground vehicle in real-time.

5. The automated cruise control system of claim 1, further comprising:
a vehicle load estimator configured to:
detect a plurality of vehicle load parameters associated with a vehicle load of the ground vehicle in real-time as the ground vehicle maneuvers along the segment of the roadway, wherein the vehicle load parameters are generated from the longitudinal operation of the ground vehicle as the ground vehicle reacts to the vehicle load as the ground vehicle maneuvers along the segment of the roadway and from a three-dimensional geometry of the segment of the road, and
determine an estimated load of the ground vehicle in real-time as the ground vehicle maneuvers along the segment of the roadway based on the vehicle load parameters detected in real-time, wherein the estimated load impacts the operation of the ground vehicle in real-time as the ground vehicle maneuvers along the segment of the roadway.

6. The automated cruise control system of claim 5, wherein the energy consumption cruise controller is further configured to:
automatically adjust the operation of the ground vehicle as the ground vehicle maneuvers along the segment of the roadway to maintain the operation of the ground vehicle within the operation threshold based on the estimated load of the ground vehicle determined in real-time, wherein the estimated load of the ground vehicle impacts the amount of overall energy consumption by the ground vehicle as the ground vehicle operates along the segment of the roadway in real-time.

7. The automated cruise control system of claim 6, wherein the vehicle load estimator is further configured to:
detect a speed/acceleration vehicle load parameter associated with the vehicle load of the ground vehicle in real-time as the ground vehicle maneuvers along the segment of the roadway, wherein the speed/acceleration vehicle load parameter is indicative as to the vehicle load of the ground vehicle in real-time as the speed/acceleration vehicle load parameter varies in real-time as the ground vehicle maneuvers along the segment of the roadway in real-time; and
determine the estimated load of the ground vehicle in real-time as the ground vehicle maneuvers along the segment of the roadway based on the speed/acceleration vehicle load parameter detected in real-time, wherein an increased speed/acceleration vehicle load parameter corresponds to an increased vehicle load of the ground vehicle.

8. The automated cruise control system of claim 7, wherein the energy consumption cruise controller is further configured to:
automatically adjust the operation of the ground vehicle in real-time as the ground vehicle maneuvers along the segment of the roadway to accommodate for the speed/acceleration vehicle load parameter as the speed/acceleration vehicle load parameter varies in real-time thereby impacting the vehicle load of the ground vehicle in real-time to maintain the operation of the ground vehicle within the operation threshold for the segment of the roadway.

9. The automated cruise control system of claim 1, further comprising:
a risk estimator configured to:
detect a plurality of driving risk conditions associated with the driving environment of the ground vehicle in real-time as the ground vehicle maneuvers along the segment of the roadway, wherein the driving risk conditions are generated from the driving environment of the segment of the roadway that the ground vehicle is operating in real-time and a driver status of a driver of the ground vehicle that is indicative of an engagement of the driver in operating the ground vehicle in real-time, and
determine an overall driving risk level for the ground vehicle as the ground vehicle maneuvers along the segment of the roadway based on the driving risk conditions detected in real-time, wherein the overall driving risk level impacts the operation of the ground vehicle in real-time as the ground vehicle maneuvers along the segment of the roadway.

10. The automated cruise control system of claim 9, wherein the energy consumption cruise controller is further configured to:
automatically adjust the operation of the ground vehicle as the ground vehicle maneuvers along the segment of the roadway to maintain the operation of the ground vehicle within the operation threshold based on the overall driving risk level of the ground vehicle determined in real-time, wherein the overall driving risk level for the ground vehicle impacts the amount of overall energy consumption by the ground vehicle as the ground vehicle operates along the segment of the roadway in real-time.

11. A method for automatically adjusting an operation of a ground vehicle as the ground vehicle maneuvers along a segment of a roadway to automatically decrease overall energy consumption of the ground vehicle, comprising:
detecting a plurality of driving parameters associated with the ground vehicle as the ground vehicle maneuvers along the segment of the roadway, wherein the driving parameters are indicative of a driving environment that the ground vehicle is operating;
detecting a plurality of ground vehicle control inputs associated with an operation of the ground vehicle as the ground vehicle maneuvers along the segment of the roadway, wherein the ground vehicle control inputs are generated from a longitudinal operation of the ground vehicle;
automatically adjusting the operation of the ground vehicle as the ground vehicle maneuvers along the segment of the roadway to maintain the operation of the ground vehicle within an operation threshold based on the detected driving parameters and ground vehicle control inputs, wherein the operation threshold is the operation of the ground vehicle that decreases an amount of overall energy consumption by the ground vehicle as the ground vehicle operates along the segment of the roadway and maintains a longitudinal speed of the ground vehicle within a longitudinal speed threshold associated with the segment of the roadway.

12. The method of claim 11, wherein the detecting of the plurality of driving parameters comprises:
detecting a plurality of visual detection driving parameters that are associated with the ground vehicle as the ground vehicle maneuvers along the segment of the roadway, wherein the visual detection driving parameters are driving parameters that are visually identifiable as detected by a plurality of visual detection devices and are indicative tot eh driving environment that the ground vehicle is operating.

13. The method of claim 11, wherein the automatic adjusting of the operation of the ground vehicle comprises:
identifying the visual detection driving parameters as detected by the visual detection devices in real-time as the ground vehicle maneuvers along the segment of the roadway;
determining an impact that each of the visual detection driving parameters are having on the driving environment that the ground vehicle is operating; and
automatically adjusting the operation of the ground vehicle as the ground vehicle maneuvers along the segment of the roadway to maintain the operation of the ground vehicle within the operation threshold to accommodate for each of the visual detection driving parameters as each visual detection driving parameter impacts the driving environment that the ground vehicle is operating in real-time.

14. The method of claim 11, wherein the automatic adjusting of the operation of the ground vehicle further comprises:
identifying each ground vehicle control input as detected by a ground vehicle control detector in real-time as the ground vehicle maneuvers along the segment of the roadway;
determining a current state of operation of the ground vehicle and a driver intent from each ground vehicle control input as the ground vehicle is operating in real-time, wherein the current state of the operation of the ground vehicle is indicative as to a current operation of the ground vehicle as the ground vehicle is operating in real-time and the driver intent is an intent that the driver requests to operate the ground vehicle in real-time; and
automatically adjusting the operation of the ground vehicle as the ground vehicle maneuvers along the segment of the roadway to accommodate for the current state of the operation of the ground vehicle and the driver intent of the driver of the ground vehicle in real-time.

15. The method of claim 11, further comprising:
detecting a plurality of vehicle load parameters associated with a vehicle load of the ground vehicle in real-time as the ground vehicle maneuvers along the segment of the roadway, wherein the vehicle load parameters are generated from the longitudinal operation of the ground vehicle as the ground vehicle reacts to the vehicle load as the ground vehicle maneuvers along the segment of the roadway and from a three-dimensional geometry of the segment of the road; and
determining an estimated load of the ground vehicle in real-time as the ground vehicle maneuvers along the segment of the roadway based on the vehicle load parameters detected in real-time, wherein the estimated load impacts the operation of the ground vehicle in real-time as the ground vehicle maneuvers along the segment of the roadway.

16. The method of claim 15, wherein the automatic adjusting of the operation of the ground vehicle further comprises:
automatically adjusting the operation of the ground vehicle as the ground vehicle maneuvers along the segment of the roadway to maintain the operation of the ground vehicle within the operation threshold based on the estimated load of the ground vehicle determined in real-time, wherein the estimated load of the ground vehicle impacts the amount of overall energy consumption by the ground vehicle as the ground vehicle operates along the segment of the roadway in real-time.

17. The method of claim 16, further comprising:
detecting a speed/acceleration vehicle load parameter associated with the vehicle load of the ground vehicle in real-time as the ground vehicle maneuvers along the segment of the roadway, wherein the speed/acceleration vehicle load parameter is indicative as to the vehicle load of the ground vehicle in real-time as the speed/acceleration vehicle load parameter varies in real-time as the ground vehicle maneuvers along the segment of the roadway in real-time; and
determining the estimated load of the ground vehicle in real-time as the ground vehicle maneuvers along the segment of the roadway based on the speed/acceleration vehicle load parameter detected in real-time, wherein an increased speed/acceleration vehicle load parameter corresponds to an increased vehicle load of the ground vehicle.

18. The method of claim 18, wherein the automatic adjusting of the operation of the ground vehicle further comprises:
automatically adjusting the operation of the ground vehicle in real-time as the ground vehicle maneuvers along the segment of the roadway to accommodate for the speed/acceleration vehicle load parameter as the speed/acceleration vehicle load parameter varies in real-time thereby impacting the vehicle load of the ground vehicle in real-time to maintain the operation of the ground vehicle within the operation threshold for the segment of the roadway.

19. The method of claim 11, further comprising:
detecting a plurality of driving risk conditions associated with the driving environment of the ground vehicle in real-time as the ground vehicle maneuvers along the segment of the roadway, wherein the driving risk conditions are generated from the driving environment of the segment of the roadway that the ground vehicle is operating in real-time and a driver status of a driver of the ground vehicle that is indicative of an engagement of the driver in operating the ground vehicle in real-time; and
determining an overall driving risk level for the ground vehicle as the ground vehicle maneuvers along the segment of the roadway based on the driving risk conditions detected in real-time, wherein the overall driving risk level impacts the operation of the ground vehicle in real-time as the ground vehicle maneuvers along the segment of the roadway.

20. The method of claim 18, wherein the automatic adjusting of the operation of the ground vehicle further comprises:
automatically adjusting the operation of the ground vehicle as the ground vehicle maneuvers along the segment of the roadway to maintain the operation of the ground vehicle as the ground vehicle maneuvers along the segment of the roadway to maintain the operation of the ground vehicle within the operation threshold based on the overall driving risk level of the ground vehicle determined in real-time, wherein the overall driving risk level for the ground vehicle impacts the amount of overall energy consumption by the ground vehicle as the ground vehicle operates along the segment of the roadway in real-time.
